(19) United States
(12) Patent Application Publication
(10) Pub. No.: US 2026/0192234 A1
(43) Pub. Date: Jul. 9, 2026

(54) SCRUBBING APPARATUS

(71) Applicant: Seung Hwan OH, Seoul (KR)

(72) Inventors: Seung Hwan OH, Seoul (KR); Gunho SHIN, Seoul (KR)

(21) Appl. No.: 19/380,344

(22) Filed: Nov. 5, 2025

Related U.S. Application Data
(63) Continuation of application No. PCT/KR2025/099136, filed on Jan. 23, 2025.

(30) Foreign Application Priority Data
Jan. 9, 2025 (KR) 10-2025-0003140

(51) Int. Cl. B01D 47/06; B01D 53/78

(52) U.S. Cl. CPC B01D 47/06; B01D 53/78; B01D 2258/0283

(57) ABSTRACT

A scrubbing apparatus comprises a scrubbing chamber defining a scrubbing space, a first scrubbing plate disposed in the scrubbing chamber, a plurality of first scrubbing holes penetrating the first scrubbing plate in a second direction, and a scrubbing solution supplying nozzle supplying a scrubbing solution to an upper surface of the first scrubbing plate, wherein each of the plurality of first scrubbing holes includes an upper opening and a lower opening opposing each other in the second direction, wherein a width of the upper opening of each of the plurality of first scrubbing holes in a first direction intersecting the second direction is greater than a width of the lower opening of each of the plurality of first scrubbing holes in the first direction, and wherein some of the impurities contained in the gas ascend through the plurality of first scrubbing holes and are dissolved in the scrubbing solution.

### TECHNICAL FIELD

The present disclosure relates to a scrubbing apparatus. Specifically, the present disclosure relates to a scrubbing apparatus configured to improve scrubbing efficiency and energy efficiency by designing an area of an upper opening of a scrubbing hole to be different from a lower opening area of the scrubbing hole.

### BACKGROUND ART

In modern industries, various types of air pollutants are generated, many of which have extremely low permissible exposure limits for humans. Accordingly, removing air pollutants from gases emitted in various industrial fields before discharge is a critical issue.

Currently used air pollution prevention facilities include dust collectors and scrubbers, and they are installed considering their efficiency depending on the type of pollutant. Among these, scrubbers are widely used because they can simultaneously process dust, exhaust gas, and high-temperature gas.

Specifically, scrubbers are classified into dry, wet, and plasma types depending on the method of treating the exhaust gas, and wet scrubbers are used in a process that causes the exhaust gas to come into contact with a liquid to dissolve water-soluble components in the gas into the liquid.

In wet scrubbers, a cleaning solution is generally used to effectively remove harmful components of the exhaust gas. When the cleaning solution comes into contact with harmful components, it removes the harmful components through a chemical reaction such as neutralization, so the one that best reacts chemically with the harmful components of the emitted gas should be selected. The performance of the wet scrubber is determined by whether the solution containing the cleaning solution can efficiently contact the exhaust gas. Accordingly, in the related art, a filler is installed to ensure sufficient contact between the cleaning solution and the discharged gas, and a spray nozzle is employed to supply a cleaning solution having fine particles.

Recently, a technology that can improve the contact area between the scrubbing solution containing the cleaning solution and the exhaust gas has been studied.

### SUMMARY

### TECHNICAL PROBLEM

The technical problem to be solved by the present disclosure is to provide a scrubbing apparatus that configured to improve scrubbing efficiency and energy efficiency by designing a width of an upper opening of a scrubbing hole to be different from a width of a lower opening of the scrubbing hole.

The problems that the present disclosure is trying to solve are not limited to the problems mentioned above, and other problems that are not mentioned can be clearly understood by those skilled in the art from the description below.

### SOLUTION TO PROBLEM

A scrubbing apparatus according to some embodiments of the present disclosure for achieving the above technical problem comprises a scrubbing chamber defining a scrubbing space in which impurities contained in a gas are scrubbed, a first scrubbing plate disposed in the scrubbing chamber, a plurality of first scrubbing holes penetrating the first scrubbing plate in a second direction, and a scrubbing solution supplying nozzle configured to supply a scrubbing solution to an upper surface of the first scrubbing plate, wherein each of the plurality of first scrubbing holes includes an upper opening and a lower opening opposing each other in the second direction, wherein a width of the upper opening of each of the plurality of first scrubbing holes in a first direction intersecting the second direction is greater than a width of the lower opening of each of the plurality of first scrubbing holes in the first direction, and wherein some of the impurities contained in the gas ascend through the plurality of first scrubbing holes and are dissolved in the scrubbing solution.

Since a width of an upper opening of the scrubbing hole is greater than a width of a lower opening of the scrubbing hole, scrubbing efficiency and energy efficiency can be improved.

In some embodiments, wherein a width of each of the plurality of first scrubbing holes in the first direction gradually decreases from the upper opening toward the lower opening.

In some embodiments, wherein the first scrubbing plate comprises a first_1 scrubbing plate and a first_2 scrubbing plate on the first_1 scrubbing plate, wherein the plurality of first scrubbing holes comprises a plurality of first_1 scrubbing holes penetrating the first_1 scrubbing plate in the second direction and a plurality of first_2 scrubbing holes penetrating the first_2 scrubbing plate in the second direction, wherein each of the plurality of first_1 scrubbing holes comprises an upper opening and a lower opening opposing each other in the second direction, wherein each of the plurality of first_2 scrubbing holes comprises an upper opening and a lower opening opposing each other in the second direction, and wherein the upper opening of each of the plurality of first_1 scrubbing holes lies in the same plane as the lower opening of each of the plurality of first_2 scrubbing holes.

In some embodiments, wherein a width of each of the plurality of first_1 scrubbing holes in the first direction is constant, and wherein a width of each of the plurality of first_2 scrubbing holes in the first direction gradually increases as moving away from the first_1 scrubbing plate in the second direction.

Wherein a width of the upper opening of each of the plurality of first_1 scrubbing holes in the first direction is the same as a width of the lower opening of each of the plurality of first_2 scrubbing holes in the first direction.

In some embodiments, wherein a width of each of the plurality of first_1 scrubbing holes in the first direction is constant, and wherein a width of each of the plurality of first_2 scrubbing holes in the first direction is constant.

In some embodiments, wherein a center of the upper opening of each of the plurality of first_1 scrubbing holes and a center of the lower opening of each of the plurality of first_2 scrubbing holes are offset from each other in the second direction.

In some embodiments, wherein the plurality of first scrubbing holes comprises a plurality of first_1 scrubbing holes and a plurality of first_2 scrubbing holes on the plurality of first_1 scrubbing holes.

In some embodiments, wherein, at a boundary between each of the plurality of first_1 scrubbing holes and each of the plurality of first_2 scrubbing holes, a width of each of the plurality of first_1 scrubbing holes in the first direction is smaller than a width of each of the plurality of first_2 scrubbing holes in the first direction.

In some embodiments, wherein a width of each of the plurality of first_2 scrubbing holes in the first direction is constant, and wherein a width of each of the plurality of first_1 scrubbing holes in the first direction gradually decreases as moving away from the plurality of first_2 scrubbing holes in the second direction.

In some embodiments, wherein, at a boundary between each of the plurality of first_1 scrubbing holes and each of the plurality of first_2 scrubbing holes, a width of each of the plurality of first_1 scrubbing holes in the first direction is equal to a width of each of the plurality of first_2 scrubbing holes in the first direction.

In some embodiments, wherein a height of each of the plurality of first_1 scrubbing holes in the second direction is different from a height of each of the plurality of first_2 scrubbing holes in the second direction.

In some embodiments, wherein each of the plurality of first_1 scrubbing holes comprises a plurality of first_1 lower scrubbing holes and a plurality of first_1 upper scrubbing holes on the plurality of first_1 lower scrubbing holes, wherein each of the plurality of first_2 scrubbing holes comprises a plurality of first_2 lower scrubbing holes and a plurality of first_2 upper scrubbing holes on the plurality of first_2 lower scrubbing holes, and wherein a volume of each of the plurality of first_1 upper scrubbing holes is greater than a volume of each of the plurality of first_2 upper scrubbing holes.

In some embodiments, wherein each of the plurality of first_1 upper scrubbing holes comprises an upper opening, wherein each of the plurality of first_2 lower scrubbing holes comprises a lower opening, and wherein the upper opening of each of the first_1 upper scrubbing holes is spaced apart from the lower opening of each of the first_2 lower scrubbing holes in the second direction.

The scrubbing apparatus according to some embodiments further comprises a second scrubbing plate disposed in the scrubbing chamber and on the first scrubbing plate, and a plurality of second scrubbing holes penetrating the second scrubbing plate in the second direction, wherein each of the plurality of second scrubbing holes comprises an upper opening and a lower opening opposing each other in the second direction, and wherein a width of the upper opening of each of the plurality of second scrubbing holes in the first direction is greater than a width of the lower opening of each of the plurality of second scrubbing holes in the first direction.

In some embodiments, wherein a shape of each of the plurality of first scrubbing holes is different from a shape of each of the plurality of second scrubbing holes.

Specific details of other embodiments are included in the specification and drawings.

### Effect Of Disclosure

The scrubbing apparatus of the present disclosure includes at least one scrubbing plate. A scrubbing hole penetrating the scrubbing plate is formed inside the scrubbing plate. As a gas ascends through the scrubbing hole, bubbles may be formed in a scrubbing solution flowing on an upper surface of the scrubbing plate.

As the bubbles are formed, a contact area between the scrubbing solution and the gas is increased. Since the contact area is increased, hydrophilic impurities contained in the gas can be more effectively dissolved in the scrubbing solution. Accordingly, gas from which impurities have been removed can be discharged to the outside of the scrubbing apparatus.

In addition, a width of an upper opening of each scrubbing hole and a width of a lower opening of the scrubbing hole may be different from each other. Specifically, the width of the upper opening of the scrubbing hole is greater than the width of the lower opening. In this case, the scrubbing solution is accumulated at the upper portion having a relatively larger area, thereby further enhancing scrubbing efficiency.

### BRIEF DESCRIPTION OF DRAWINGS

FIG. 1 is a drawing briefly explaining a scrubbing system including a scrubbing apparatus to some embodiments of the present disclosure.

FIG. 2 is an exemplary perspective view for explaining the scrubbing apparatus of FIG. 1.

FIG. 3 is an exemplary cross-sectional view for explaining the scrubbing apparatus of FIG. 1.

FIG. 4 is an enlarged view of the P area, and Q area of FIG. 3.

FIG. 5 is an enlarged view of the P1 area of FIG. 4.

FIGS. 6, 7, 8, 9, 10, 11, 12, 13, 14, 15, 16, 17, 18, 19 and 20 are drawings for explaining the scrubbing apparatus according to some other embodiments of the present disclosure, respectively.

FIG. 21 is a drawing for explaining an operating method of a scrubbing apparatus according to some embodiments of the present disclosure.

### DETAILED DESCRIPTION OF EXEMPLARY EMBODIMENTS

Hereinafter, preferred embodiments of the present disclosure will be described in detail with reference to the accompanying drawings. The advantages and features of the present disclosure and the methods for achieving them will become apparent with reference to the embodiments described in detail below together with the accompanying drawings. However, the present disclosure is not limited to the embodiments described below, but may be implemented in various different forms, and these embodiments are provided only to make the disclosure of the present disclosure complete and to fully inform those skilled in the art of the scope of the disclosure, and the present disclosure is defined only by the scope of the claims. Like reference numerals refer to like elements throughout the specification.

In addition, the terminology used herein is for the purpose of describing embodiments, and is not intended to limit and/or restrict the disclosed disclosure. The singular expression includes the plural expression unless the context clearly indicates otherwise. In this specification, the terms "comprises", "include", or "has" and the like are intended to specify that a feature, number, step, operation, component, part, or combination thereof described in the specification is present, but do not exclude in advance the possibility of the presence or addition of one or more other features, numbers, steps, operations, components, parts, or combinations thereof.

In addition, terms including ordinal numbers such as "first", "second", etc. used in this specification may be used to describe various components, but the components are not limited by the terms, and the terms are used only for the purpose of distinguishing one component from another. For example, without departing from the scope of the present disclosure, the first component may be named the second component, and similarly, the second component may also be named the first component. The term "and/or" includes a combination of multiple related described items or any item among multiple related described items.

Meanwhile, the terms "front", "rear", "upper", "lower", "front", and "lower" used in the following description are defined based on the drawings, and the shape and position of each component are not limited by these terms.

The terms used in this specification are for describing embodiments and are not intended to limit the present disclosure. In this specification, the singular includes the plural unless specifically stated in the phrase. The terms "comprise" and/or "comprising" used in the specification do not exclude the presence or addition of one or more other components, steps, operations, and/or elements mentioned.

Unless otherwise defined, all terms (including technical and scientific terms) used in this specification may be used in a meaning that can be commonly understood by a person of ordinary skill in the art to which the present disclosure belongs. In addition, terms defined in commonly used dictionaries shall not be ideally or excessively interpreted unless explicitly specifically defined.

Hereinafter, embodiments of the present disclosure will be described in detail with reference to the attached drawings, and when describing with reference to the attached drawings, identical or corresponding components will be given the same reference numerals regardless of the drawing numbers, and redundant descriptions thereof will be omitted.

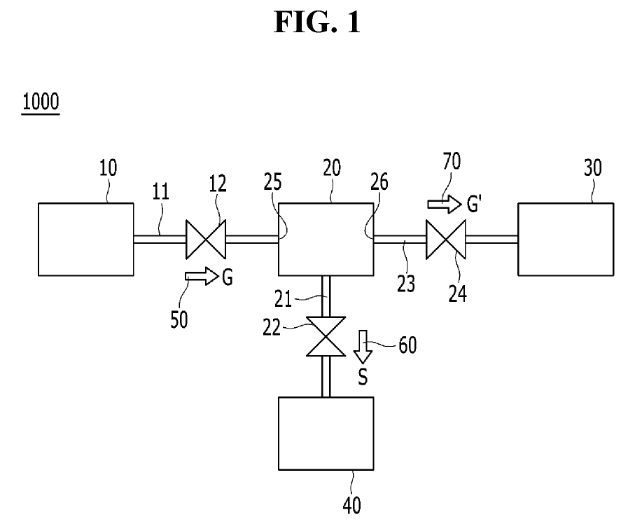

Hereinafter, first, a scrubbing system 1000 including a scrubbing apparatus 20 according to some embodiments of the present disclosure will be described with reference to FIG. 1. FIG. 1 is a drawing briefly explaining the scrubbing system including the scrubbing apparatus according to some embodiments of the present disclosure.

Referring to FIG. 1, the scrubbing system 1000 according to some embodiments of the present disclosure may include a process chamber 10, a scrubbing apparatus 20, an exhaust gas discharge chamber 30, and a scrubbing solution discharge chamber 40.

The process chamber 10 may be a chamber utilized in various industrial fields. The various industrial fields may be a plant field, a battery field, a thermal power plant field, a steel field, a semiconductor field, a chemical field, and/or an oil and gas plant field.

If the scrubbing system 1000 is utilized in the semiconductor field, the process chamber 10 may be a chamber in which a semiconductor process is performed. In order to manufacture a semiconductor device, various semiconductor processes must be performed on a wafer. For example, a film must be deposited on the wafer(deposition process), and the film must be etched (etching process) to form a pattern included in the semiconductor device. In addition, after the deposition process and/or the etching process are performed, a cleaning process must be performed to clean the wafer and/or the process chamber 10.

The deposition process may include, for example, physical vapor deposition (PVD), chemical vapor deposition (CVD), and/or atomic layer deposition (ALD). The etching process may include, for example, a dry etching process, a wet etching process, and/or an ashing process. The cleaning process may include, for example, a wet cleaning process, a dry cleaning process, and/or a vapor cleaning process.

If the scrubbing system 1000 is utilized in the oil and gas plant industry, the process chamber 10 may be a chamber where the plant process is performed.

When various processes are performed in the process chamber 10, various byproducts may be generated. The byproducts may include substances harmful to the human body, and if the byproducts include substances harmful to the human body, they must be removed and discharged. The scrubbing apparatus 20 may be used to remove substances harmful to the human body and the byproducts generated in the process chamber 10.

A first pipe 11 may be disposed between the process chamber 10 and the scrubbing apparatus 20. One end of the first pipe 11 may be connected to the process chamber 10, and the other end of the first pipe 11 may be connected to the scrubbing apparatus 20. A gas G discharged from the process chamber 10 may be provided to the scrubbing apparatus 20 through the first pipe 11 (see reference numeral 50). The gas G may contain impurities. The impurities may be substances harmful to the human body. The impurities may contain hydrophilic substances.

In some embodiments, a first valve 12 may be connected to the first pipe 11. The first valve 12 may control the pressure and flow rate of the gas G provided to the scrubbing apparatus 20 through the first pipe 11.

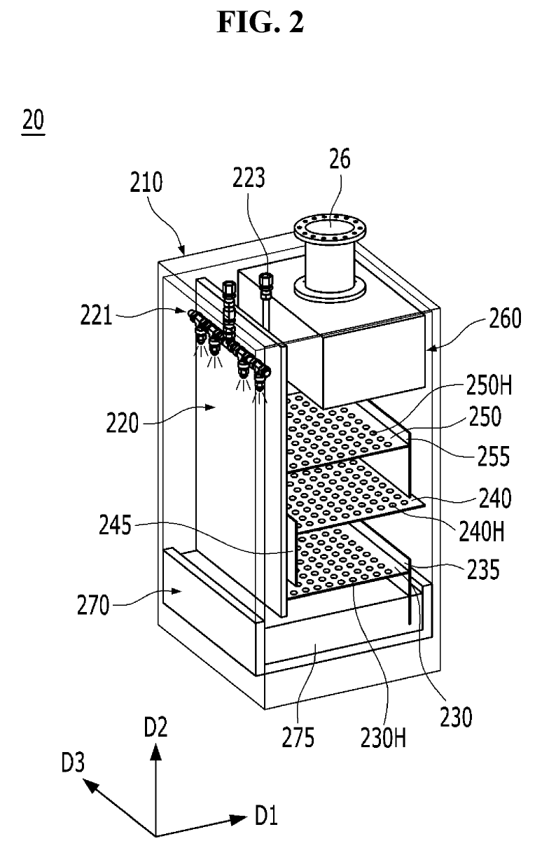

The scrubbing apparatus 20 may scrub the gas G provided from the process chamber 10. The impurities contained in the gas G may be dissolved in a scrubbing solution and stored in thescrubbing solution discharge chamber 40. The gas G from which the impurities have been removed may be stored in the exhaust gas discharge chamber 30. A detailed description of the scrubbing apparatus 20 will be described later using FIGS. 2 to 15.

The scrubbing solution discharge chamber 40 may be connected to the scrubbing apparatus 20. The scrubbing solution discharge chamber 40 and the scrubbing apparatus 20 may be connected to each other through a second pipe 21. One end of the second pipe 21 may be connected to the scrubbing apparatus 20, and the other end of the second pipe 21 may be connected the scrubbing solution discharge chamber 40. Through the second pipe 21, the scrubbing solution S in which impurities are dissolved may move from the scrubbing apparatus 20 to the scrubbing solution discharge chamber 40 (see reference numeral 60).

In some embodiments, a second valve 22 may be connected to the second pipe 21. The second valve 22 may control the pressure and flow rate of the scrubbing solution S containing dissolved impurities, which is supplied to the scrubbing solution discharge chamber 40 through the second pipe 21.

The exhaust gas discharge chamber 30 may be connected to the scrubbing apparatus 20. The exhaust gas discharge chamber 30 and the scrubbing apparatus 20 may be connected to each other through a third pipe 23. One end of the third pipe 23 may be connected to the scrubbing apparatus 20, and the other end of the third pipe 23 may be connected to the exhaust gas discharge chamber 30. Through the third pipe 23, the gas G' from which impurities have been removed may move from the scrubbing apparatus 20 to the exhaust gas discharge chamber 30 (see reference numeral 70).

In some embodiments, a third valve 24 may be connected to the third pipe 23. The third valve 24 may control the pressure and flow rate of the gas G' from which impurities have been removed and provided to the exhaust gas discharge chamber 30 through the third pipe 23.

In some embodiments, the scrubbing apparatus 20 may further include a gas inlet port 25 and a gas outlet port 26. The gas G may be introduced into the scrubbing apparatus 20 through the gas inlet port 25. The gas G from which impurities have been removed may be discharged to the exterior of the scrubbing apparatus 20 through the gas outlet port 26.

When the scrubbing apparatus 20 according to some embodiments of the present disclosure is utilized in the industrial field, pollutants generated after the process may be effectively separated and removed. Accordingly, environmental pollution problems may be reduced.

Referring to FIG. 2 to FIG. 5, the scrubbing apparatus according to some embodiments of the present disclosure will now be described in detail.

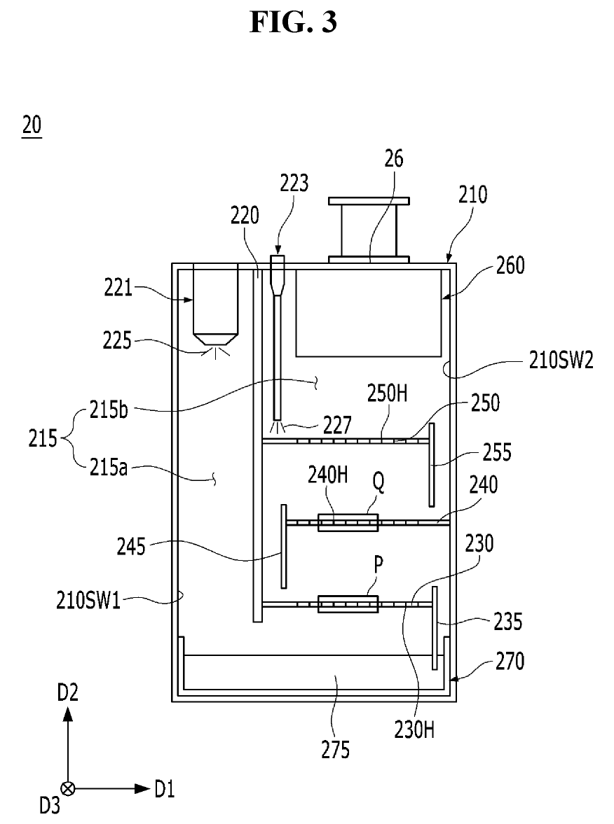

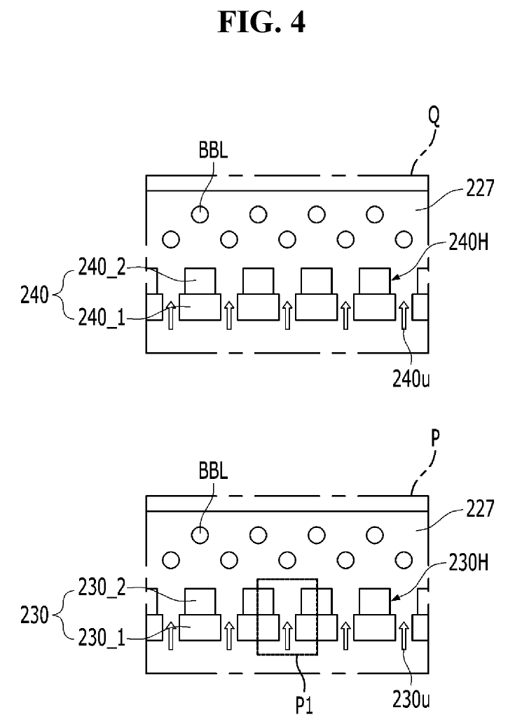

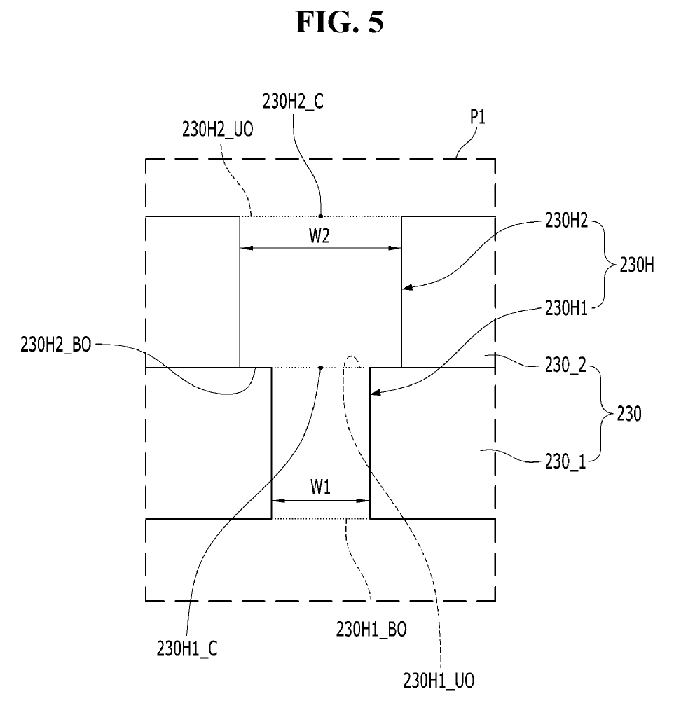

FIG. 2 is an exemplary perspective view for explaining the scrubbing apparatus of FIG. 1. FIG. 3 is an exemplary cross-sectional view for explaining the scrubbing apparatus of FIG. 1. FIG. 4 is an enlarged view of the P area, and Q area of FIG. 3. FIG. 5 is an enlarged view of the P1 area of FIG. 4.

Referring to FIGS. 2 to 5, a scrubbing apparatus 20 according to some embodiments of the present disclosure may include a scrubbing chamber 210, a separating wall 220, a first scrubbing plate 230, a second scrubbing plate 240, a third scrubbing plate 250, a spray nozzle 221, a scrubbing solution supply nozzle 223, and a demister 260.

First, the scrubbing chamber 210 may be provided. The scrubbing chamber 210 may serve as an outer housing of the scrubbing apparatus 20. The gas (G of FIG. 1) may be introduced into an interior of the scrubbing chamber 210. The gas may contain impurities. For example, the gas G may be introduced into the interior of the scrubbing chamber 210 through a gas inlet port (25 of FIG. 1). The gas inlet port may be formed at an upper wall of the scrubbing chamber 210 or at a side wall of the scrubbing chamber 210. In addition, the gas inlet port may be formed at an upper portion of the side wall or at a lower portion of the side wall of the scrubbing chamber 210.

Impurities contained in the gas (G of FIG. 1) may be dissolved in a scrubbing solution inside the scrubbing chamber 210. The scrubbing chamber 210 may define a scrubbing space 215. The scrubbing space 215 may be a space in which a scrubbing process is performed, in which impurities contained in the gas (G of FIG. 1) are dissolved in the scrubbing solution.

In some embodiments, the scrubbing space 215 may include a first sub-space 215a and a second sub-space 215b. The first sub-space 215a and the second sub-space 215b may be separated by the separating wall 220. The first sub-space 215a and the second sub-space 215b may be defined by the separating wall 220.

The separating wall 220 may be disposed inside the scrubbing chamber 210. In some embodiments, the separating wall 220 may be attached to the upper wall of the scrubbing chamber 210. The separating wall 220 may extend from the upper wall of the scrubbing chamber 210 in a second direction D2. The second direction D2 may be a direction perpendicular to the ground.

In some embodiments, the separating wall 220 may have a bar shape in a planar view. The separating wall 220 may extend in a third direction D3 in the planar view. One end of the separating wall 220 may be connected in contact with a third inner side wall of the scrubbing chamber 210, and the other end of the separating wall 220 may be connected in contact with a fourth inner side wall of the scrubbing chamber 210. The separating wall 220 may include a long side extending in the third direction D3 and a short side extending in a first direction D1, however, the technical scope of the present disclosure is not limited thereto.

In some embodiments, the scrubbing chamber 210 may include a first inner side wall 210SW1, a second inner side wall 210SW2, the third inner side wall, and the fourth inner side wall.

The first inner side wall 210SW1 of the scrubbing chamber 210 may face the separating wall 220. The second inner side wall 210SW2 of the scrubbing chamber 210 may face the first inner side wall 210SW1 in the first direction D1. The third inner side wall and the fourth inner side wall may face each other in the third direction D3 and may intersect with the first inner side wall 210SW1 and the second inner side wall 210SW2, respectively.

The separating wall 220 may define the first sub-space 215a and the second sub-space 215b. The separating wall 220 may divide the scrubbing space 215 into the first sub-space 215a and the second sub-space 215b.

A first scrubbing process may be performed in the first sub-space 215a. A second scrubbing process may be performed in the second sub-space 215b. The first scrubbing process may be a process in which a portion of the impurities is dissolved in a first scrubbing solution 225. The second scrubbing process may be a process in which another portion of the impurities is dissolved in a second scrubbing solution 227.

In the present specification, the first direction D1 and the third direction D3 may intersect each other. The first direction D1 and the second direction D2 may intersect each other. The second direction D2 and the third direction D3 may intersect each other. That is, in the present specification, the first direction D1, the second direction D2, and the third direction D3 may be substantially perpendicular to one another.

A first scrubbing plate 230, a second scrubbing plate 240, and a third scrubbing plate 250 may be disposed inside the scrubbing space 215. Specifically, the first scrubbing plate 230, the second scrubbing plate 240, and the third scrubbing plate 250 may be disposed inside the second sub-space 215b.

In FIGS. 2 to 5, the scrubbing apparatus 20 of the present disclosure is illustrated as including three scrubbing plates; however, the technical scope of the present disclosure is not limited thereto. The scrubbing apparatus 20 according to some embodiments of the present disclosure may include two or more scrubbing plates. That is, the scrubbing plates may be disposed in the second sub-space 215b in two, or four or more, as will be readily understood.

The first scrubbing plate 230 may be disposed at a lowermost position among the scrubbing plates disposed in the second sub-space 215b. One end of the first scrubbing plate 230 may be connected and fixed to the separating wall 220. Specifically, one end of the first scrubbing plate 230 may be connected and fixed to a side wall of the separating wall 220 that faces the second sub-space 215b. The first scrubbing plate 230 may extend in the first direction D1 intersecting the separating wall 220 while being connected to the separating wall 220. More specifically, the first scrubbing plate 230 may be disposed on a plane defined by the first direction D1 and the third direction D3.

In some embodiments, another portion of the first scrubbing plate 230 may be connected and fixed to inner side walls of the scrubbing chamber 210. Specifically, the first scrubbing plate 230 may be connected to the separating wall 220, the third inner side wall of the scrubbing chamber 210, and the fourth inner side wall of the scrubbing chamber 210 in the second sub-space 215b.

However, the first scrubbing plate 230 may not be connected and fixed to the second inner side wall 210SW2 of the scrubbing chamber 210. The first scrubbing plate 230 may be spaced apart from the second inner side wall 210SW2 of the scrubbing chamber 210 in the first direction D1. A space between the other end of the first scrubbing plate 230 and the second inner side wall 210SW2 of the scrubbing chamber 210 may serve as a space through which the second scrubbing solution 227, which will be described later, flows downward (for example, in the second direction D2).

The scrubbing apparatus 20 according to some embodiments may further include first scrubbing holes 230H and first scrubbing walls 235.

The first scrubbing holes 230H may be formed inside the first scrubbing plate 230. The first scrubbing holes 230H may extend from a lower surface of the first scrubbing plate 230 to an upper surface of the first scrubbing plate 230. That is, the first scrubbing holes 230H may penetrate the first scrubbing plate 230 in the second direction D2. The gas (G of FIG. 1) may ascend in the second direction D2 through the first scrubbing holes 230H (see reference numeral 230u).

The upper surface of the first scrubbing plate 230 may face the demister 260, which will be described later, and the lower surface of the first scrubbing plate 230 may face a scrubbing solution storage tank 270, which will be described later.

The first scrubbing wall 235 may be attached to the other end of the first scrubbing plate 230. The first scrubbing wall 235 may be interposed between the first scrubbing plate 230 and the second inner side wall 210SW2 of the scrubbing chamber 210. The first scrubbing wall 235 may extend in the second direction D2.

In some embodiments, a portion of the first scrubbing wall 235 may protrude in the second direction D2 from the upper surface of the first scrubbing plate 230. Another portion of the first scrubbing wall 235 may protrude in the second direction D2 from the lower surface of the first scrubbing plate 230.

A length of the portion of the first scrubbing wall 235 that protrudes in the second direction D2 from the upper surface of the first scrubbing plate 230 may be smaller than a length of the portion of the first scrubbing wall 235 that protrudes in the second direction D2 from the lower surface of the first scrubbing plate 230; however, the technical scope of the present disclosure is not limited thereto.

In some embodiments, at least a portion of the part of the first scrubbing wall 235 that protrudes in the second direction D2 from the lower surface of the first scrubbing plate 230 may be disposed in a scrubbing solution 275 in which impurities are dissolved; however, the technical scope of the present disclosure is not limited thereto.

In some embodiments, the first scrubbing plate 230 may include a first_1 scrubbing plate 230_1 and a first_2 scrubbing plate 230_2.

The first_2 scrubbing plate 230_2 may be disposed on the first_1 scrubbing plate 230_1. An upper surface of the first_2 scrubbing plate 230_2 may serve as the upper surface of the first scrubbing plate 230. A lower surface of the first_1 scrubbing plate 230_1 may serve as the lower surface of the first scrubbing plate 230.

A lower surface of the first_2 scrubbing plate 230_2 may be bonded to upper surface of the first_1 scrubbing plate 230_1. For example, after the first_1 scrubbing plate 230_1 and the first_2 scrubbing plate 230_2 are separately manufactured, the first_1 scrubbing plate 230_1 and the first_2 scrubbing plate 230_2 may be bonded to each other to form the first scrubbing plate 230.

In some embodiments, the first scrubbing holes 230H may include first_1 scrubbing holes 230H1 and first_2 scrubbing holes 230H2.

The first_1 scrubbing holes 230H1 may be formed inside the first_1 scrubbing plate 230_1. The first_1 scrubbing holes 230H1 may penetrate the first_1 scrubbing plate 230_1 in the second direction D2. The first_2 scrubbing holes 230H2 may be formed inside the first_2 scrubbing plate 230_2. The first_2 scrubbing holes 230H2 may penetrate the first_2 scrubbing plate 230_2 in the second direction D2.

The first_1 scrubbing holes 230H1 may include upper openings 230H1_UO and lower openings 230H1_BO. The first_2 scrubbing holes 230H2 may include upper openings 230H2_UO and lower openings 230H2_BO.

The upper openings 230H2_UO of the first_2 scrubbing holes 230H2 may serve as upper openings of the first scrubbing holes 230H. The upper openings of the first scrubbing holes 230H may lie in the same plane as the upper surface of the first scrubbing plate 230. The lower openings 230H1_BO of the first_1 scrubbing holes 230H1 may serve as lower openings of the first scrubbing holes 230H. The lower openings of the first scrubbing holes 230H may lie in the same plane as the lower surface of the first scrubbing plate 230. The upper openings of the first scrubbing holes 230H and the lower openings of the first scrubbing holes 230H may oppose each other in the second direction D2.

The lower openings 230H2_BO of the first_2 scrubbing holes 230H2 may lie in the same plane as the upper openings 230H1_UO of the first_1 scrubbing holes 230H1. That is, the lower openings 230H2_BO of the first_2 scrubbing holes 230H2 and the upper openings 230H1_UO of the first_1 scrubbing holes 230H1 may serve as a boundary between the first_1 scrubbing holes 230H1 and the first_2 scrubbing holes 230H2.

In some embodiments, a width of the upper opening of the first scrubbing hole 230H in the first direction D1 may be greater than a width of the lower opening of the first scrubbing hole 230H in the first direction D1. In other words, a width at a lower portion of the first scrubbing hole 230H may be smaller than a width at an upper portion of the first scrubbing hole 230H. Stated differently, a cross-sectional area of the upper opening of the first scrubbing hole 230H may be greater than a cross-sectional area of the lower opening of the first scrubbing hole 230H.

In some embodiments, a width of the upper opening 230H2_UO of the first_2 scrubbing hole 230H2 in the first direction D1 may be greater than a width of the lower opening 230H1_BO of the first_1 scrubbing hole 230H1 in the first direction D1. In addition, a cross-sectional area of the upper opening 230H2_UO of the first_2 scrubbing hole 230H2 may be greater than a cross-sectional area of the lower opening 230H1_BO of the first_1 scrubbing hole 230H1. Furthermore, a volume of the first_2 scrubbing hole 230H2 may be greater than a volume of the first_1 scrubbing hole 230H1.

As the scrubbing apparatus according to some embodiments of the present disclosure has the above-described structure, scrubbing efficiency and energy efficiency may be improved.

In some embodiments, a width W1 of the first_1 scrubbing hole 230H1 in the first direction D1 may be constant. In other words, the width of the upper opening 230H1_UO of the first_1 scrubbing hole 230H1 in the first direction D1 may be the same as the width of the lower opening 230H1_BO of the first_1 scrubbing hole 230H1 in the first direction D1.

A width W2 of the first_2 scrubbing hole 230H2 in the first direction D1 may be constant. In other words, the width of the upper opening 230H2_UO of the first_2 scrubbing hole 230H2 in the first direction D1 may be the same as the width of the lower opening 230H2_BO of the first_2 scrubbing hole 230H2 in the first direction D1. However, the technical scope of the present disclosure is not limited thereto.

In some embodiments, at a boundary between the first_1 scrubbing hole 230H1 and the first_2 scrubbing hole 230H2, the width W1 of the first_1 scrubbing hole 230H1 in the first direction D1 may be different from the width W2 of the first_2 scrubbing hole 230H2 in the first direction D1.

For example, at a boundary between the first_1 scrubbing hole 230H1 and the first_2 scrubbing hole 230H2, the width W1 of the first_1 scrubbing hole 230H1 in the first direction D1 may be smaller than the width W2 of the first_2 scrubbing hole 230H2 in the first direction. D1. In other words, the width of the upper opening 230H1_UO of the first_1 scrubbing hole 230H1 in the first direction D1 may be smaller than the width of the lower opening 230H2_BO of the first_2 scrubbing hole 230H2 in the first direction D1. However, the technical scope of the present disclosure is not limited thereto.

In some embodiments, a center 230H1_C of the upper opening 230H1_UO of the first_1 scrubbing hole 230H1 may overlap in the second direction D2 with a center 230H2_C of the upper opening 230H2_UO of the first_2 scrubbing hole 230H2. The center 230H1_C of the upper opening 230H1_UO of the first_1 scrubbing hole 230H1 may be a point equidistant from side walls of the first_1 scrubbing hole 230H1. The center 230H2_C of the upper opening 230H2_UO of the first_2 scrubbing hole 230H2 may be a point equidistant from side walls of the first_2 scrubbing hole 230H2.

In another sense, the center 230H1_C of the upper opening 230H1_UO of the first_1 scrubbing hole 230H1 may be a centroid of the upper opening 230H1_UO of the first_1 scrubbing hole 230H1. The center 230H2_C of the upper opening 230H2_UO of the first_2 scrubbing hole 230H2 may be a centroid of the upper opening 230H2_UO of the first_2 scrubbing hole 230H2. However, the technical scope of the present disclosure is not limited thereto.

The second scrubbing plate 240 may be disposed on the first scrubbing plate 230. Specifically, the second scrubbing plate 240 may be disposed on the upper surface of the first scrubbing plate 230. One end of the second scrubbing plate 240 may be connected and fixed to the second inner side wall 210SW2 of the scrubbing chamber 210. The second scrubbing plate 240 may extend in the first direction D1 intersecting the second inner side wall 210SW2 of the scrubbing chamber 210 while being connected to the second inner side wall 210SW2. More specifically, the second scrubbing plate 240 may be disposed on a plane defined by the first direction D1 and the third direction D3.

Similarly, the second scrubbing plate 240 may be connected and fixed to the third inner side wall and the fourth inner side wall of the scrubbing chamber 210. However, the other end of the second scrubbing plate 240 may not be connected and fixed to the separating wall 220. The other end of the second scrubbing plate 240 may be spaced apart from the separating wall 220 in the first direction D1. A space between the other end of the second scrubbing plate 240 and the separating wall 220 may serve as a space through which the second scrubbing solution 227, which will be described later, flows downward (for example, in the second direction D2).

The second scrubbing plate 240 may be substantially the same as the first scrubbing plate 230. For example, the second scrubbing plate 240 may include a second_1 scrubbing plate 240_1 and a second_2 scrubbing plate 240_2 on the second_1 scrubbing plate 240_1. However, the technical scope of the present disclosure is not limited thereto.

The scrubbing apparatus 20 according to some embodiments may further include second scrubbing holes 240H and a second scrubbing wall 245.

The second scrubbing holes 240H may be formed inside the second scrubbing plate 240. The second scrubbing holes 240H may extend from a lower surface of the second scrubbing plate 240 to an upper surface of the second scrubbing plate 240. The second scrubbing holes 240H may penetrate the second scrubbing plate 240 in the second direction D2. The gas (G of FIG. 1) may ascend in the second direction D2 through the second scrubbing holes 240H (see reference numeral 240u).

The second scrubbing holes 240H may be substantially the same as the first scrubbing holes 230H. A shape of the second scrubbing holes 240H may be the same as a shape of the first scrubbing holes 230H. For example, similar to the first scrubbing holes 230H described above, the second scrubbing holes 240H may include second_1 scrubbing holes and second_2 scrubbing holes. In addition, a width of an upper opening of the second scrubbing holes 240H in the first direction D1 may be greater than a width of a lower opening of the second scrubbing holes 240H in the first direction D1.

The upper surface of the second scrubbing plate 240 may face a demister 260, which will be described later, and the lower surface of the second scrubbing plate 240 may face the upper surface of the first scrubbing plate 230.

A second scrubbing wall 245 may be attached to the other end of the second scrubbing plate 240. The second scrubbing wall 245 may be interposed between the second scrubbing plate 240 and the separating wall 220. The second scrubbing wall 245 may extend in the second direction D2. In some embodiments, a portion of the second scrubbing wall 245 may protrude in the second direction D2 from the upper surface of the second scrubbing plate 240. Another portion of the second scrubbing wall 245 may protrude in the second direction D2 from the lower surface of the second scrubbing plate 240.

A length of the portion of the second scrubbing wall 245 that protrudes in the second direction D2 from the upper surface of the second scrubbing plate 240 may be smaller than a length of the portion of the second scrubbing wall 245 that protrudes in the second direction D2 from the lower surface of the second scrubbing plate 240; however, the technical scope of the present disclosure is not limited thereto.

In some embodiments, the first scrubbing plate 230 and the second scrubbing plate 240 may not completely overlap each other in the second direction D2. The first scrubbing plate 230 and the second scrubbing plate 240 may be arranged in a zigzag manner. Accordingly, the second scrubbing solution 227 flowing downward beyond the second scrubbing wall 245 may be discharged onto the upper surface of the first scrubbing plate 230. In other words, a center of the first scrubbing plate 230 and a center of the second scrubbing plate 240 may be offset from each other.

The third scrubbing plate 250 may be disposed on the second scrubbing plate 240. Specifically, the third scrubbing plate 250 may be disposed on the upper surface of the second scrubbing plate 240. One end of the third scrubbing plate 250 may be connected and fixed to the separating wall 220.

Specifically, one end of the third scrubbing plate 250 may be connected and fixed to the side wall of the separating wall 220 that faces the second sub-space 215b. The third scrubbing plate 250 may extend in the first direction D1 intersecting the separating wall 220 while being connected to the separating wall 220. More specifically, the third scrubbing plate 250 may be disposed on a plane defined by the first direction D1 and the third direction D3. Similarly, the third scrubbing plate 250 may be connected and fixed to the third inner side wall and the fourth inner side wall of the scrubbing chamber 210.

However, the other end of the third scrubbing plate 250 may not be connected and fixed to the second inner side wall 210SW2 of the scrubbing chamber 210. The other end of the third scrubbing plate 250 may be spaced apart from the second inner side wall 210SW2 of the scrubbing chamber 210 in the first direction D1. A space between the other end of the third scrubbing plate 250 and the second inner side wall 210SW2 of the scrubbing chamber 210 may serve as a space through which the second scrubbing solution 227, which will be described later, flows downward (for example, in the second direction D2).

The third scrubbing plate 250 may be substantially the same as the first scrubbing plate 230. For example, the third scrubbing plate 250 may include a third_1 scrubbing plate and a third_2 scrubbing plate on the third_1 scrubbing plate. However, the technical scope of the present disclosure is not limited thereto.

The scrubbing apparatus 20 according to some embodiments may further include third scrubbing holes 250H and a third scrubbing wall 255.

The third scrubbing holes 250H may be formed inside the third scrubbing plate 250. The third scrubbing holes 250H may extend from a lower surface of the third scrubbing plate 250 to an upper surface of the third scrubbing plate 250. The third scrubbing holes 250H may penetrate the third scrubbing plate 250 in the second direction D2. The gas (G of FIG. 1) may ascend in the second direction D2 through the third scrubbing holes 250H (see reference numeral 250u).

The third scrubbing holes 250H may be substantially the same as the first scrubbing holes 230H. A shape of the third scrubbing holes 250H may be the same as a shape of the first scrubbing holes 230H. For example, similar to the first scrubbing holes 230H described above, the third scrubbing holes 250H may include third_1 scrubbing holes and third_2 scrubbing holes. In addition, a width of an upper opening of the third scrubbing holes 250H in the first direction D1 may be greater than a width of a lower opening of the third scrubbing holes 250H in the first direction D1.

The upper surface of the third scrubbing plate 250 may face a demister 260, which will be described later, and the lower surface of the third scrubbing plate 250 may face the upper surface of the second scrubbing plate 240.

The third scrubbing wall 255 may be attached to the other end of the third scrubbing plate 250. The third scrubbing wall 255 may be interposed between the third scrubbing plate 250 and the second inner side wall 210SW2 of the scrubbing chamber 210. The third scrubbing wall 255 may extend in the second direction D2.

In some embodiments, a portion of the third scrubbing wall 255 may protrude in the second direction D2 from the upper surface of the third scrubbing plate 250. Another portion of the third scrubbing wall 255 may protrude in the second direction D2 from the lower surface of the third scrubbing plate 250.

A length of the portion of the third scrubbing wall 255 that protrudes in the second direction D2 from the upper surface of the third scrubbing plate 250 may be smaller than a length of the portion of the third scrubbing wall 255 that protrudes in the second direction D2 from the lower surface of the third scrubbing plate 250; however, the technical scope of the present disclosure is not limited thereto.

In some embodiments, the third scrubbing plate 250 and the second scrubbing plate 240 may not completely overlap each other in the second direction D2. The third scrubbing plate 250 and the second scrubbing plate 240 may be arranged in a zigzag manner. The second scrubbing solution 227 flowing downward beyond the third scrubbing wall 255 may be discharged onto the upper surface of the second scrubbing plate 240. In other words, a center of the third scrubbing plate 250 and a center of the second scrubbing plate 240 may be offset from each other.

However, the third scrubbing plate 250 and the first scrubbing plate 230 may completely overlap each other in the second direction D2. That is, a center of the third scrubbing plate 250 and a center of the first scrubbing plate 230 may overlap in the second direction D2.

In some embodiments, the first to third scrubbing holes 230H, 240H, and 250H may completely overlap in the second direction D2. However, the technical scope of the present disclosure is not limited thereto. The first to third scrubbing holes 230H, 240H, and 250H may not completely overlap in the second direction D2, or may partially overlap.

In some embodiments, the first and second scrubbing solutions 225 and 227 may be water. The first and second scrubbing solutions 225 and 227 may be the same.

After being discharged onto the upper surface of the third scrubbing plate 250, the second scrubbing solution 227 may flow toward the third scrubbing wall 255 on the upper surface of the third scrubbing plate 250 while the second scrubbing process is performed. At this time, the second scrubbing solution 227 does not flow downward through the third scrubbing holes 250H. Instead, the second scrubbing solution 227 may flow downward beyond the third scrubbing wall 255 to a lower part of the scrubbing chamber 210.

The second scrubbing solution 227 that has passed beyond the third scrubbing wall 255 may be discharged again onto the upper surface of the second scrubbing plate 240. The second scrubbing solution 227 may flow toward the second scrubbing wall 245 on the upper surface of the second scrubbing plate 240 while the second scrubbing process is performed.

The second scrubbing solution 227 disposed on the upper surface of the second scrubbing plate 240 does not flow downward through the second scrubbing holes 240H. Instead, the second scrubbing solution 227 may flow downward beyond the second scrubbing wall 245 to the lower part of the scrubbing chamber 210.

Similarly, the second scrubbing solution 227 that has passed beyond the second scrubbing wall 245 may be discharged again onto the upper surface of the first scrubbing plate 230. The second scrubbing solution 227 may flow toward the first scrubbing wall 235 on the upper surface of the first scrubbing plate 230 while the second scrubbing process is performed.

At this time, the second scrubbing solution 227 does not flow downward through the first scrubbing holes 230H. Instead, the second scrubbing solution 227 may flow downward beyond the first scrubbing wall 235 to the lower part of the scrubbing chamber 210.

Finally, the second scrubbing solution 227 that has passed beyond the first scrubbing wall 235 may be stored in the scrubbing solution storage tank 270 provided at the lower part of the scrubbing chamber 210. The scrubbing solution 275 in which impurities are dissolved may be stored in the scrubbing solution storage tank 270. For example, the scrubbing solution 275 in which impurities are dissolved may be a solution in which hydrophilic gas is dissolved into the second scrubbing solution 227.

In some embodiments, the hydrophilic gas may be IPA (isopropyl alcohol) and/or ammonia; however, the technical scope of the present disclosure is not limited thereto.

The demister 260 may be disposed at an upper part of the scrubbing chamber 210. The demister 260 may be used to remove moisture from the gas after the first scrubbing process and the second scrubbing process are performed. After the first scrubbing process and the second scrubbing process are performed, the gas (G of FIG. 1) from which impurities have been removed may be provided. That is, by using the demister 260, moisture may be removed from the gas G from which impurities have been removed after the first scrubbing process and the second scrubbing process are performed.

The demister 260 may be connected to the gas outlet port 26. The gas filtered through the demister 260 may be discharged to the outside of the scrubbing chamber 210 through the gas outlet port 26.

When the scrubbing apparatus 20 according to some embodiments is used, harmful gases (e.g., impurities) to the human body may be dissolved in the scrubbing solution. Accordingly, harmful gases generated as by-products after various processes in various industrial fields may be removed and discharged to the outside of the scrubbing chamber 210.

In some embodiments, the first sub-space 215a may be defined by the first inner side wall 210SW1 of the scrubbing chamber 210 and the separating wall 220. For example, the first sub-space 215a may be defined by the first inner side wall 210SW1 of the scrubbing chamber 210, the third inner side wall of the scrubbing chamber 210, the fourth inner side wall of the scrubbing chamber 210, and the separating wall 220.

The first scrubbing process may be performed in the first sub-space 215a.

Specifically, a first scrubbing solution 225 may be supplied into the scrubbing chamber 210 through a spray nozzle 221. The first scrubbing solution 225 may be provided into the first sub-space 215a through the spray nozzle 221.

The first scrubbing solution 225 may be supplied from an upper part of the first sub-space 215a toward a lower part of the first sub-space 215a, and while the gas (G of FIG. 1) flows from the upper part of the first sub-space 215a toward the lower part of the first sub-space 215a, at least a portion of impurities contained in the gas may be dissolved in the first scrubbing solution 225. In some embodiments, the first scrubbing solution 225 may include water; however, the technical scope of the present disclosure is not limited thereto.

In some embodiments, the spray nozzle 221 may be a spray nozzle. The spray nozzle 221 may supply the first scrubbing solution 225, having fine particles, into the first sub-space 215a. Accordingly, a contact area between the first scrubbing solution 225 and the gas may be increased. Thus, the scrubbing apparatus 20 with improved scrubbing efficiency may be provided.

The spray nozzle 221 may be installed at the upper part of the scrubbing chamber 210. Although not illustrated, the spray nozzle 221 may be connected to a pipe installed outside the scrubbing chamber 210.

In some embodiments, the gas inlet port may be provided at one side of the first sub-space 215a. The gas (G of FIG. 1) introduced into the scrubbing chamber 210 may be supplied into the interior of the scrubbing chamber 210 through the gas inlet port. The gas inlet port may be connected to the first pipe 11, and since the other side of the first pipe 11 is connected to the process chamber (10 of FIG. 1), the gas G introduced through the gas inlet port may be supplied from the process chamber.

In some embodiments, a negative pressure may be provided in the scrubbing space 215 through the gas inlet port and the gas outlet port 26. For example, a pressure at the gas inlet port and a pressure at the gas outlet port 26 may be different from each other. Accordingly, the gas G may flow from the gas inlet port toward the gas outlet port 26. The first scrubbing process and the second scrubbing process may be performed by utilizing a pressure difference between the gas inlet port and the gas outlet port 26.

In some embodiments, the first sub-space 215a and the second sub-space 215b may be connected to each other at the lower part of the scrubbing chamber 210. The first sub-space 215a and the second sub-space 215b may be connected to each other above the scrubbing solution storage tank 270.

That is, the gas introduced into the first sub-space 215a may flow from the upper part of the first sub-space 215a toward the lower part of the first sub-space 215a, and may be introduced into the second sub-space 215b from the lower part of the scrubbing chamber 210. In the second sub-space 215b, the gas (G of FIG. 1) may ascend in the second direction D2.

When the scrubbing apparatus 20 according to some embodiments is used, a contact area between the scrubbing solution and the gas may be increased. Specifically, bubbles may be formed in the scrubbing solution to increase the contact area between the scrubbing solution and the gas.

For example, in FIG. 4, the gas (G of FIG. 1) may ascend in the second direction D2 through the first scrubbing holes 230H (see reference numeral 230u).

After the gas G ascends through the first scrubbing holes 230H, bubbles BBL may be formed on the upper surface of the first scrubbing plate 230. The bubbles BBL may be formed inside the second scrubbing solution 227. The bubbles BBL may be bubbles generated in the second scrubbing solution 227 due to pressure of the gas attempting to ascend in the second direction D2. At portions where the bubbles BBL contact the second scrubbing solution 227, impurities contained in the gas may be dissolved in the second scrubbing solution 227.

Subsequently, the gas may ascend in the second direction D2 through the second scrubbing holes 240H (see reference numeral 240u).

After the gas (G of FIG. 1) ascends through the second scrubbing holes 240H, bubbles BBL may be formed on the upper surface of the second scrubbing plate 240. The bubbles BBL may be formed inside the second scrubbing solution 227. The bubbles BBL may be bubbles generated in the second scrubbing solution 227 due to pressure of the gas attempting to ascend in the second direction D2. At portions where the bubbles BBL contact the second scrubbing solution 227, impurities contained in the gas may be dissolved in the second scrubbing solution 227.

Although not illustrated, after the gas (G of FIG. 1) ascends through the third scrubbing holes 250H, the gas (G of FIG. 1) may ascend in the second direction D2 through the third scrubbing holes 250H. After the gas (G of FIG. 1) ascends through the third scrubbing holes 250H, bubbles may be formed on an upper surface of the third scrubbing plate 250.

When bubbles BBL are formed in the second scrubbing solution 227, a contact area between the gas and the scrubbing solution may be increased. Accordingly, the scrubbing apparatus 20 with improved scrubbing efficiency may be provided.

As described above, since a width of the first scrubbing holes 230H is larger at an upper portion than at a lower portion, impurities contained in the gas may be more effectively dissolved in the second scrubbing solution 227 on the first scrubbing plate 230. Similarly, since a width of the second scrubbing holes 240H is larger at an upper portion than at a lower portion, impurities contained in the gas may be more effectively dissolved in the second scrubbing solution 227 on the second scrubbing plate 240. Therefore, the scrubbing apparatus with improved scrubbing efficiency may be provided.

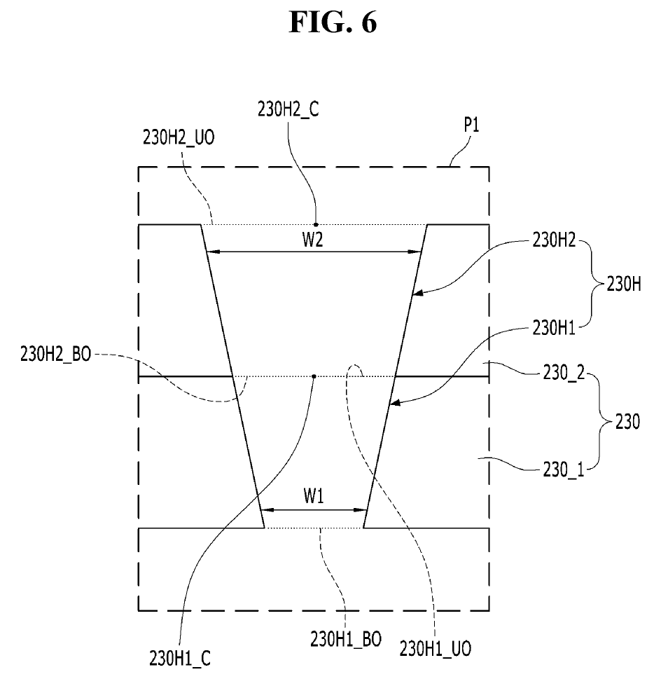

Hereinafter, referring to FIGS. 6 to 20, scrubbing apparatuses according to other embodiments of the present disclosure will be described. For convenience of explanation, descriptions overlapping with those provided with reference to FIGS. 2 to 5 will be briefly explained or omitted.

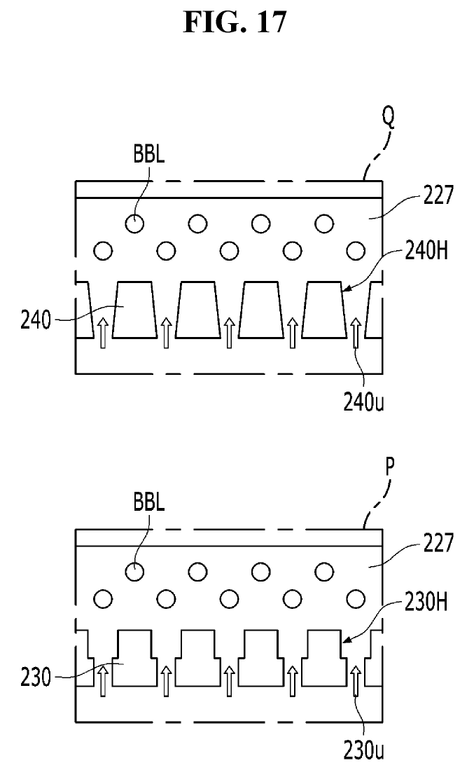

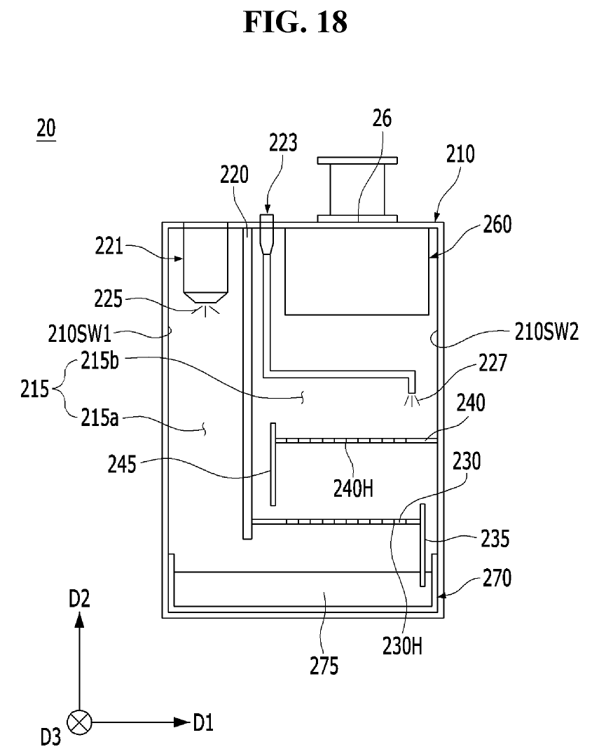

FIGS. 6 to 20 are drawings for explaining the scrubbing apparatus according to some other embodiments of the present disclosure, respectively. For reference, FIGS. 6 to 16 may each be drawings illustrating scrubbing holes according to other embodiments of the present disclosure. FIG. 17 may be a drawing illustrating enlarged views of the P and Q regions of FIG. 3. FIGS. 18 to 20 may each be cross-sectional views of scrubbing apparatuses according to other embodiments of the present disclosure.

First, referring to FIG. 6, the width W1 of the first_1 scrubbing hole 230H1 in the first direction D1 may not be constant. The width W2 of the first_2 scrubbing hole 230H2 in the first direction D1 may not be constant.

For example, the width W1 of the first_1 scrubbing hole 230H1 in the first direction D1 may gradually increase toward the first_2 scrubbing hole 230H2. The width W1 of the first_1 scrubbing hole 230H1 in the first direction D1 may gradually decrease as moving away from the first_2 scrubbing hole 230H2.

The width W2 of the first_2 scrubbing hole 230H2 in the first direction D1 may gradually decrease toward the first_1 scrubbing hole 230H1. The width W2 of the first_2 scrubbing hole 230H2 in the first direction D1 may gradually increase as moving away from the first_1 scrubbing hole 230H1.

At this time, at a boundary between the first_1 scrubbing hole 230H1 and the first_2 scrubbing hole 230H2, the width of the first_1 scrubbing hole 230H1 and a width of the first_2 scrubbing hole 230H2 may be the same. That is, the width of the upper opening 230H1_UO of the first_1 scrubbing hole 230H1 may be the same as the width of the lower opening 230H2_BO of the first_2 scrubbing hole 230H2. However, the technical scope of the present disclosure is not limited thereto.

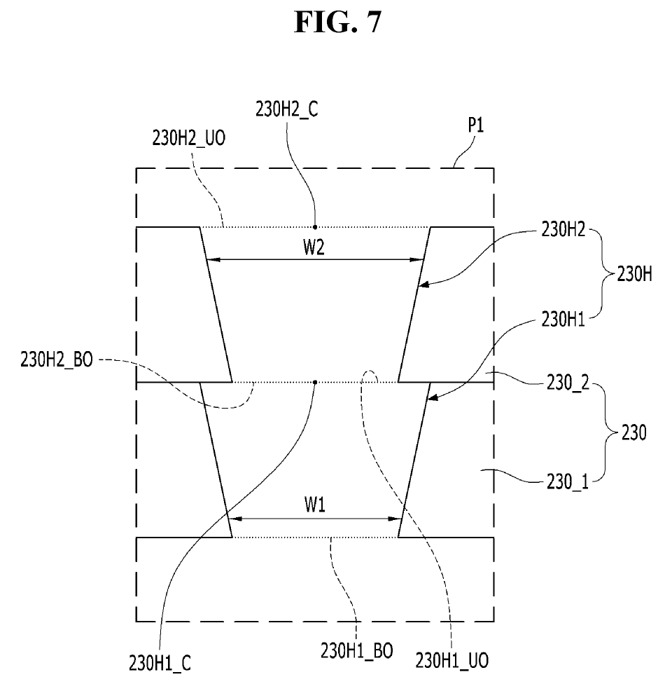

Referring to FIG. 7, the width W1 of the first_1 scrubbing hole 230H1 in the first direction D1 may not be constant. The width W2 of the first_2 scrubbing hole 230H2 in the first direction D1 may not be constant.

For example, the width W1 of the first_1 scrubbing hole 230H1 in the first direction D1 may gradually increase toward the first_2 scrubbing hole 230H2. The width W1 of the first_1 scrubbing hole 230H1 in the first direction D1 may gradually decrease as moving away from the first_2 scrubbing hole 230H2.

The width W2 of the first_2 scrubbing hole 230H2 in the first direction D1 may gradually decrease toward the first_1 scrubbing hole 230H1. The width W2 of the first_2 scrubbing hole 230H2 in the first direction D1 may gradually increase as moving away from the first_1 scrubbing hole 230H1.

In addition, at a boundary between the first_1 scrubbing hole 230H1 and the first_2 scrubbing hole 230H2, the width of the first_1 scrubbing hole 230H1 in the first direction D1 may be different from the width of the first_2 scrubbing hole 230H2 in the first direction D1.

For example, at a boundary between the first_1 scrubbing hole 230H1 and the first_2 scrubbing hole 230H2, the width of the first_1 scrubbing hole 230H1 in the first direction D1 may be greater than the width of the first_2 scrubbing hole 230H2 in the first direction D1. That is, the width of the upper opening 230H1_UO of the first_1 scrubbing hole 230H1 in the first direction D1 may be greater than the width of the lower opening 230H2_BO of the first_2 scrubbing hole 230H2 in the first direction D1.

In some embodiments, the width of the upper opening 230H1_UO of the first_1 scrubbing hole 230H1 in the first direction D1 may be the same as a width of the upper opening 230H2_UO of the first_2 scrubbing hole 230H2 in the first direction D1. Similarly, the width of the lower opening 230H1_BO of the first_1 scrubbing hole 230H1 in the first direction D1 may be the same as the width of the lower opening 230H2_BO of the first_2 scrubbing hole 230H2 in the first direction D1.

In other words, the volume of the first_1 scrubbing hole 230H1 formed in the first_1 scrubbing plate 230_1 may be the same as the volume of the first_2 scrubbing hole 230H2 formed in the first_2 scrubbing plate 230_2. However, the technical scope of the present disclosure is not limited thereto.

In FIG. 7, the center 230H1_C of the upper opening 230H1_UO of the first_1 scrubbing hole 230H1 may overlap in the second direction D2 with the center 230H2_C of the upper opening 230H2_UO of the first_2 scrubbing hole 230H2. However, the technical scope of the present disclosure is not limited thereto.

The center 230H1_C of the upper opening 230H1_UO of the first_1 scrubbing hole 230H1 may be offset in the second direction D2 from the center 230H2_C of the upper opening 230H2_UO of the first_2 scrubbing hole 230H2. In the process of bonding the first_1 scrubbing plate 230_1 and the first_2 scrubbing plate 230_2 to each other, the center 230H1_C of the upper opening 230H1_UO of the first_1 scrubbing hole 230H1 may also be offset in the second direction D2 from the center 230H2_C of the upper opening 230H2_UO of the first_2 scrubbing hole 230H2.

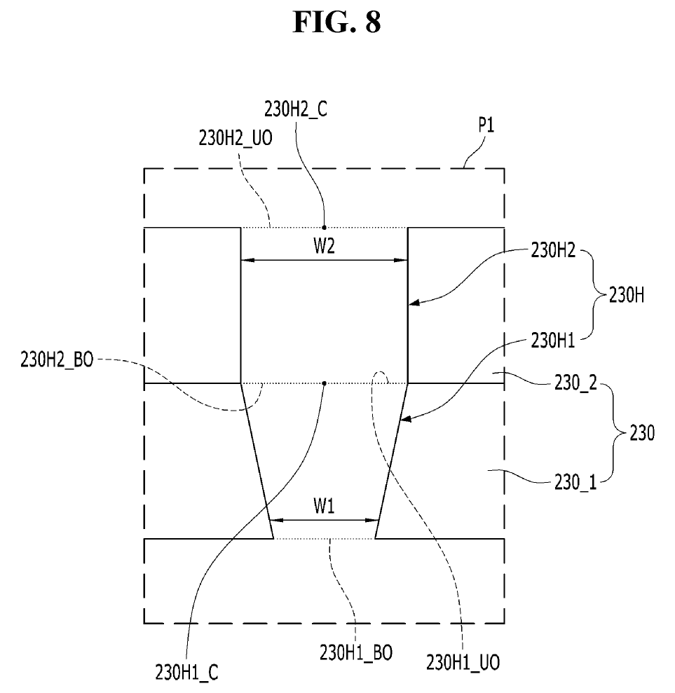

Referring to FIG. 8, the width W1 of the first_1 scrubbing hole 230H1 in the first direction D1 may not be constant. The width W2 of the first_2 scrubbing hole 230H2 in the first direction D1 may be constant.

For example, the width W1 of the first_1 scrubbing hole 230H1 in the first direction D1 may gradually increase toward the first_2 scrubbing hole 230H2. The width W1 of the first_1 scrubbing hole 230H1 in the first direction D1 may gradually decrease as moving away from the first_2 scrubbing hole 230H2.

Also in this case, the width of the upper opening 230H2_UO of the first_2 scrubbing hole 230H2 in the first direction D1 is greater than the width of the lower opening 230H1_BO of the first_1 scrubbing hole 230H1 in the first direction D1.

In some embodiments, at a boundary between the first_1 scrubbing hole 230H1 and the first_2 scrubbing hole 230H2, the width of the first_1 scrubbing hole 230H1 and the width of the first_2 scrubbing hole 230H2 may be the same. That is, the width of the upper opening 230H1_UO of the first_1 scrubbing hole 230H1 may be the same as the width of the lower opening 230H2_BO of the first_2 scrubbing hole 230H2. The width of the upper opening 230H1_UO of the first_1 scrubbing hole 230H1 may also be the same as the width of the upper opening 230H2_UO of the first_2 scrubbing hole 230H2. However, the technical scope of the present disclosure is not limited thereto.

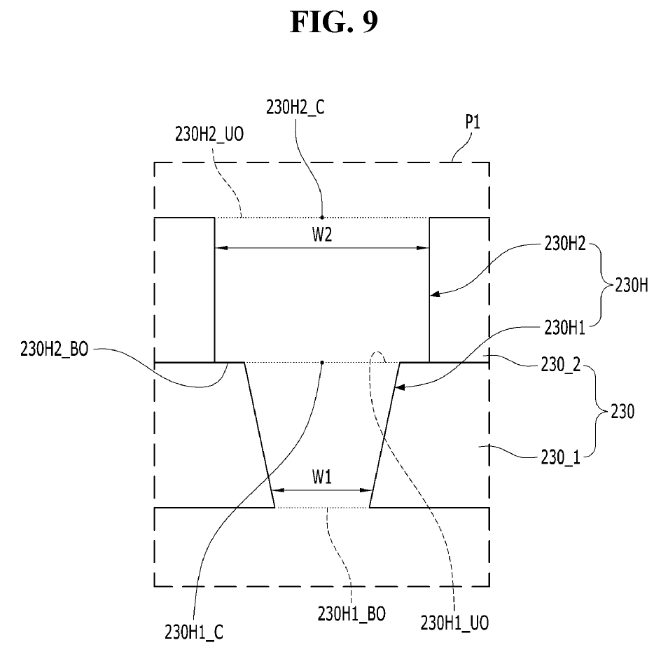

Referring to FIG. 9, the width W1 of the first_1 scrubbing hole 230H1 in the first direction D1 may not be constant. The width W2 of the first_2 scrubbing hole 230H2 in the first direction D1 may be constant.

For example, the width W1 of the first_1 scrubbing hole 230H1 in the first direction D1 may gradually increase toward the first_2 scrubbing hole 230H2. The width W1 of the first_1 scrubbing hole 230H1 in the first direction D1 may gradually decrease as moving away from the first_2 scrubbing hole 230H2.

Also in this case, the width of the upper opening 230H2_UO of the first_2 scrubbing hole 230H2 in the first direction D1 is greater than the width of the lower opening 230H1_BO of the first_1 scrubbing hole 230H1 in the first direction D1.

At a boundary between the first_1 scrubbing hole 230H1 and the first_2 scrubbing hole 230H2, the width of the first_1 scrubbing hole 230H1 in the first direction D1 may be different from the width of the first_2 scrubbing hole 230H2 in the first direction D1.

For example, at the boundary between the first_1 scrubbing hole 230H1 and the first_2 scrubbing hole 230H2, the width of the first_1 scrubbing hole 230H1 in the first direction D1 may be smaller than the width of the first_2 scrubbing hole 230H2 in the first direction D1.

In other words, the width of the upper opening 230H1_UO of the first_1 scrubbing hole 230H1 may be smaller than the width of the lower opening 230H2_BO of the first_2 scrubbing hole 230H2.

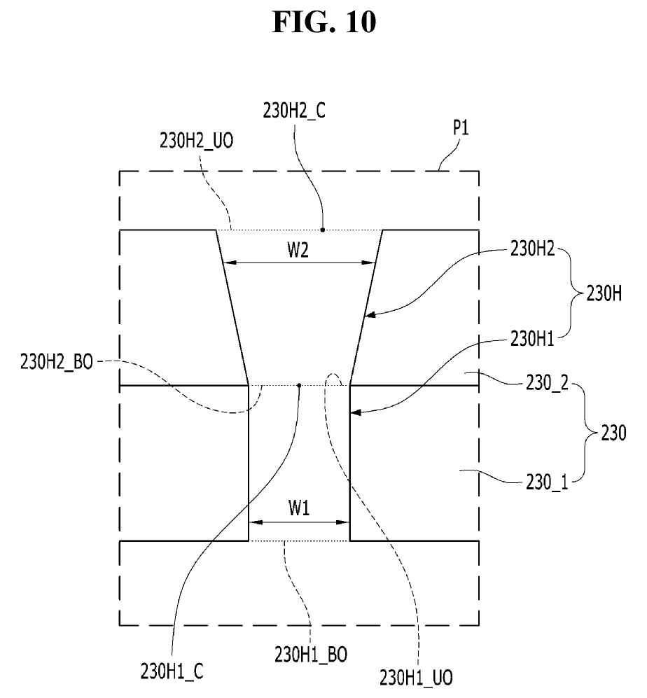

Referring to FIG. 10, the width W1 of the first_1 scrubbing hole 230H1 in the first direction D1 may be constant. In addition, the width W2 of the first_2 scrubbing hole 230H2 in the first direction D1 may not be constant.

For example, the width W2 of the first_2 scrubbing hole 230H2 in the first direction D1 may gradually decrease toward the first_1 scrubbing hole 230H1. The width W2 of the first_2 scrubbing hole 230H2 in the first direction D1 may gradually increase as moving away from the first_1 scrubbing hole 230H1.

Also in this case, the width of the upper opening 230H2_UO of the first_2 scrubbing hole 230H2 in the first direction D1 may be greater than the width of the lower opening 230H1_BO of the first_1 scrubbing hole 230H1 in the first direction D1.

In some embodiments, at a boundary between the first_1scrubbing hole 230H1 and the first_2 scrubbing hole 230H2, the width of the first_1 scrubbing hole 230H1 and the width of the first_2 scrubbing hole 230H2 may be the same. That is, the width of the upper opening 230H1_UO of the first_1 scrubbing hole 230H1 may be the same as the width of the lower opening 230H2_BO of the first_2 scrubbing hole 230H2. In addition, the width of the lower opening 230H2_BO of the first_2 scrubbing hole 230H2 may be the same as the width of the lower opening 230H1_BO of the first_1 scrubbing hole 230H1. However, the technical scope of the present disclosure is not limited thereto.

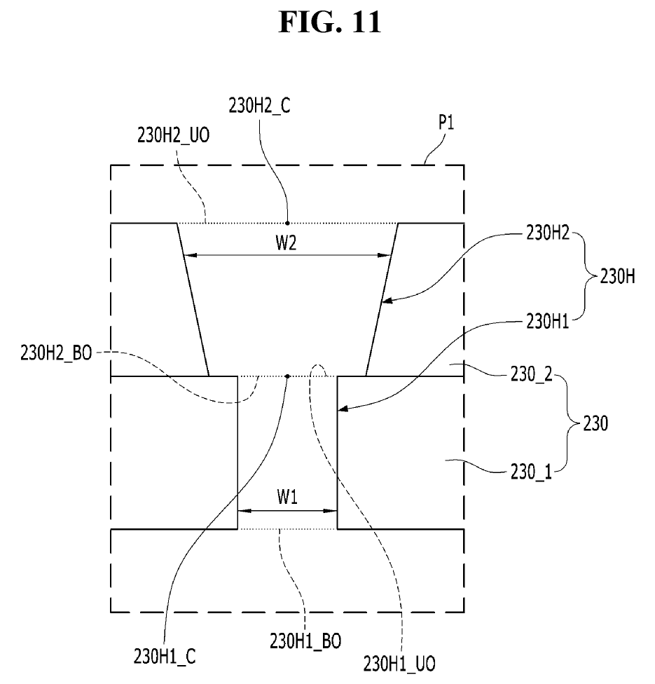

Referring to FIG. 11, the width W1 of the first_1 scrubbing hole 230H1 in the first direction D1 may be constant. In addition, the width W2 of the first_2 scrubbing hole 230H2 in the first direction D1 may not be constant.

For example, the width W2 of the first_2 scrubbing hole 230H2 in the first direction D1 may gradually decrease toward the first_1 scrubbing hole 230H1. The width W2 of the first_2scrubbing hole 230H2 in the first direction D1 may gradually increase as moving away from the first_1 scrubbing hole 230H1.

Also in this case, the width of the upper opening 230H2_UO of the first_2 scrubbing hole 230H2 in the first direction D1 may be greater than the width of the lower opening 230H1_BO of the first_1 scrubbing hole 230H1 in the first direction D1.

Unlike FIG. 10, at a boundary between the first_1 scrubbing hole 230H1 and the first_2 scrubbing hole 230H2, the width of the first_1 scrubbing hole 230H1 in the first direction D1 may be different from the width of the first_2 scrubbing hole 230H2 in the first direction D1.

For example, at the boundary between the first_1 scrubbing hole 230H1 and the first_2 scrubbing hole 230H2, the width of the first_1 scrubbing hole 230H1 in the first direction D1 may be smaller than the width of the first_2 scrubbing hole 230H2 in the first direction D1.

In other words, the width of the upper opening 230H1_UO of the first_1 scrubbing hole 230H1 may be smaller than the width of the lower opening 230H2_BO of the first_2 scrubbing hole 230H2.

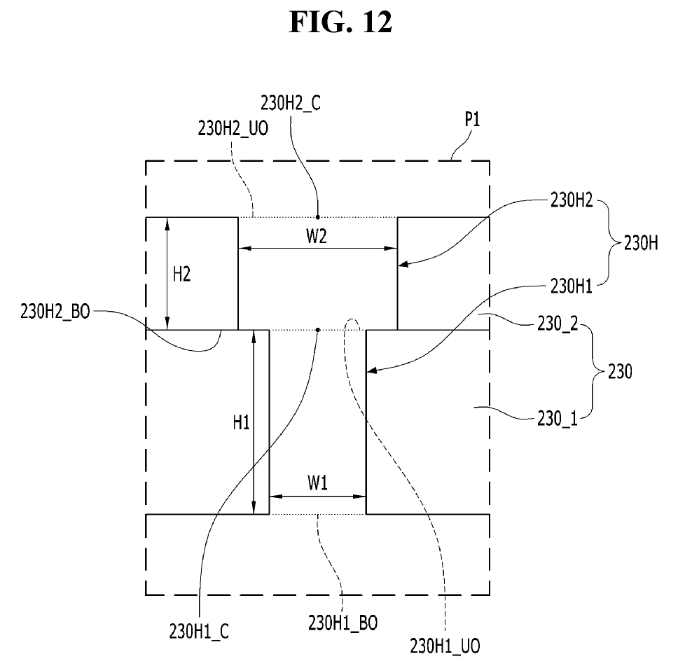

Referring to FIG. 12, the first_1 scrubbing plate 230_1 may have a first height H1 in the second direction D2. The first height H1 may be a vertical distance in the second direction D2 from the lower opening 230H1_BO of the first_1 scrubbing hole 230H1 to the upper opening 230H1_UO of the first_1 scrubbing hole 230H1. In other words, the first height H1 may be a height of the first_1 scrubbing hole 230H1 in the second direction D2.

The first_2 scrubbing plate 230_2 may have a second height H2 in the second direction D2. The second height H2 may be a vertical distance in the second direction D2 from the lower opening 230H2_BO of the first_2 scrubbing hole 230H2 to the upper opening 230H2_UO of the first_2 scrubbing hole 230H2. In other words, the second height H2 may be a height of the first_2 scrubbing hole 230H2 in the second direction D2.

In some embodiments, the first height H1 may be different from the second height H2. For example, the first height H1 may be greater than the second height H2. Since the width W1 of the first_1 scrubbing hole 230H1 in the first direction D1 may be smaller than the width W2 of the first_2 scrubbing hole 230H2 in the first direction D1, the first height H1 may be greater than the second height H2. Accordingly, a scrubbing apparatus with improved stability may be provided.

However, the technical scope of the present disclosure is not limited thereto. Unlike what is illustrated, the first height H1 may of course be smaller than the second height H2.

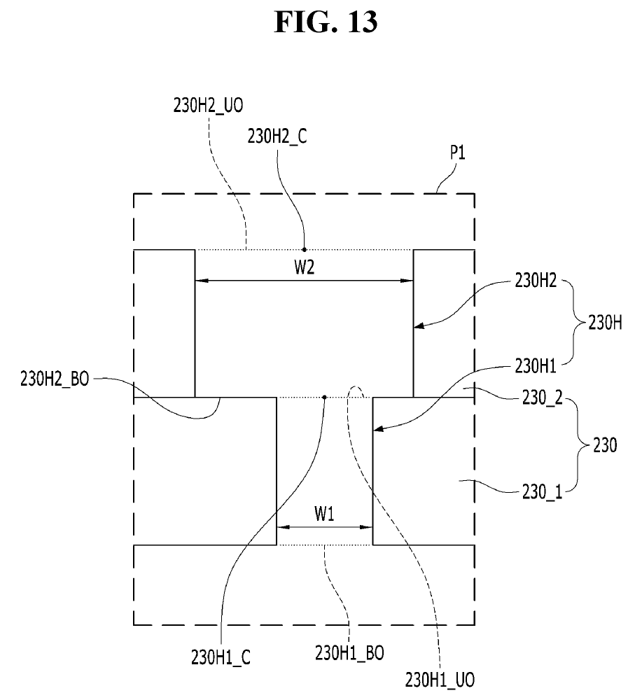

Referring to FIG. 13, the center 230H1_C of the upper opening 230H1_UO of the first_1 scrubbing hole 230H1 may be offset in the second direction D2 from the center 230H2_C of the upper opening 230H2_UO of the first_2 scrubbing hole 230H2. The center 230H1_C of the upper opening 230H1_UO of the first_1 scrubbing hole 230H1 may not overlap in the second direction D2 with the center 230H2_C of the upper opening 230H2_UO of the first_2 scrubbing hole 230H2.

In a process of bonding the first_1 scrubbing plate 230_1 and the first_2 scrubbing plate 230_2 to each other, the center 230H1_C of the upper opening 230H1_UO of the first_1 scrubbing hole 230H1 may be offset in the second direction D2 from the center 230H2_C of the upper opening 230H2_UO of the first_2 scrubbing hole 230H2.

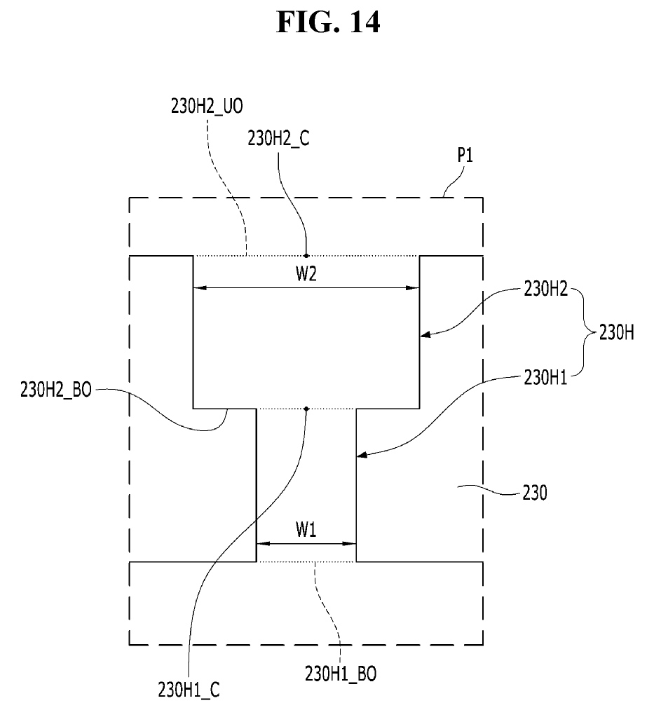

Referring to FIG. 14, the first scrubbing plate 230 may not include a first_1 scrubbing plate and a first_2 scrubbing plate. That is, both the first_1 scrubbing holes 230H1 and the first_2 scrubbing holes 230H2 may be formed in the first scrubbing plate 230.

The first scrubbing plate 230 may be provided, and first, the first_2 scrubbing holes 230H2 may be formed. Subsequently, the first_1 scrubbing holes 230H1 may be formed.

At this time, at a boundary between the first_1 scrubbing holes 230H1 and the first_2 scrubbing holes 230H2, the width of the first_1 scrubbing holes 230H1 in the first direction D1 may be different from the width of the first_2 scrubbing holes 230H2 in the first direction D1.

In addition, the width of the upper opening 230H1_UO of the first_1 scrubbing holes 230H1 in the first direction D1 may be smaller than the width of the lower opening 230H2_BO of the first_2 scrubbing holes 230H2 in the first direction D1.

Furthermore, the width of the lower opening 230H1_BO of the first_1 scrubbing holes 230H1 in the first direction D1 may be smaller than the width of the upper opening 230H2_UO of the first_2 scrubbing holes 230H2 in the first direction D1.

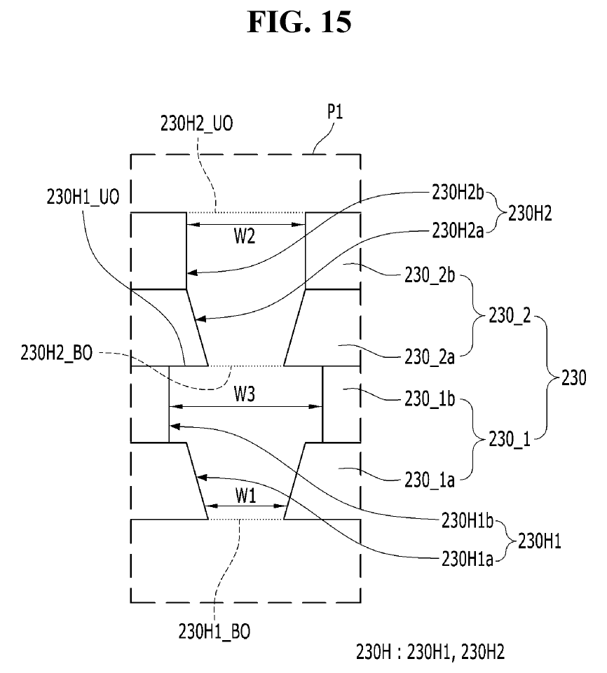

Referring to FIG. 15, the first_1 scrubbing plate 230_1 may include a first_1 lower scrubbing plate 230_1a and a first_1 upper scrubbing plate 230_1b. The first_2 scrubbing plate 230_2 may include a first_2 lower scrubbing plate 230_2a and a first_2 upper scrubbing plate 230_2b.

The first_1 upper scrubbing plate 230_1b may be disposed on the first_1 lower scrubbing plate 230_1a. The first_2 upper scrubbing plate 230_2b may be disposed on the first_2 lower scrubbing plate 230_2a.

In some embodiments, the first_1 scrubbing hole 230H1 may include a first_1 lower scrubbing hole 230H1a and a first_1 upper scrubbing hole 230H1b. The first_1 upper scrubbing hole 230H1b may be disposed on the first_1 lower scrubbing hole 230H1a. The first_1 lower scrubbing hole 230H1a may penetrate the first_1 lower scrubbing plate 230_1a in the second direction D2. The first_1 upper scrubbing hole 230H1b may penetrate the first_1 upper scrubbing plate 230_1b in the second direction D2.

The first_2 scrubbing hole 230H2 may include a first_2 lower scrubbing hole 230H2a and a first_2 upper scrubbing hole 230H2b. The first_2 upper scrubbing hole 230H2b may be disposed on the first_2 lower scrubbing hole 230H2a. The first_2 lower scrubbing hole 230H2a may penetrate the first_2 lower scrubbing plate 230_2a in the second direction D2. The first_2 upper scrubbing hole 230H2b may penetrate the first_2 upper scrubbing plate 230_2b in the second direction D2.

In some embodiments, the upper opening 230H2_UO of the first_2 scrubbing hole 230H2 may have the width W2 in the first direction D1. The lower opening 230H1_BO of the first_1 scrubbing hole 230H1 may have the width W1 in the first direction D1. The upper opening 230H1_UO of the first_1 scrubbing hole 230H1 may have a width W3 in the first direction D1.

In some embodiments, the width W2 in the first direction D1 of the upper opening 230H2_UO of the first_2 scrubbing hole 230H2 may be greater than the width W1 in the first direction D1 of the lower opening 230H1_BO of the first_1 scrubbing hole 230H1. In addition, the width W3 in the first direction D1 of the upper opening 230H1_UO of the first_1 scrubbing hole 230H1 may be greater than the width W1 in the first direction D1 of the lower opening 230H1_BO of the first_1 scrubbing hole 230H1. Furthermore, the width W3 in the first direction D1 of the upper opening 230H1_UO of the first_1 scrubbing hole 230H1 may be greater than the width W2 in the first direction D1 of the upper opening 230H2_UO of the first_2 scrubbing hole 230H2.

In other words, a volume of the first_1 upper scrubbing hole 230H1b may be greater than a volume of the first_2 upper scrubbing hole 230H2b. In this case, a volume of the first_1 lower scrubbing hole 230H1a may be smaller than a volume of the first_2 upper scrubbing hole 230H2b.

In some embodiments, a volume of the first_1 lower scrubbing hole 230H1a may be greater or smaller than a volume of the first_2 lower scrubbing hole 230H2a. The technical scope of the present disclosure is not limited thereto.

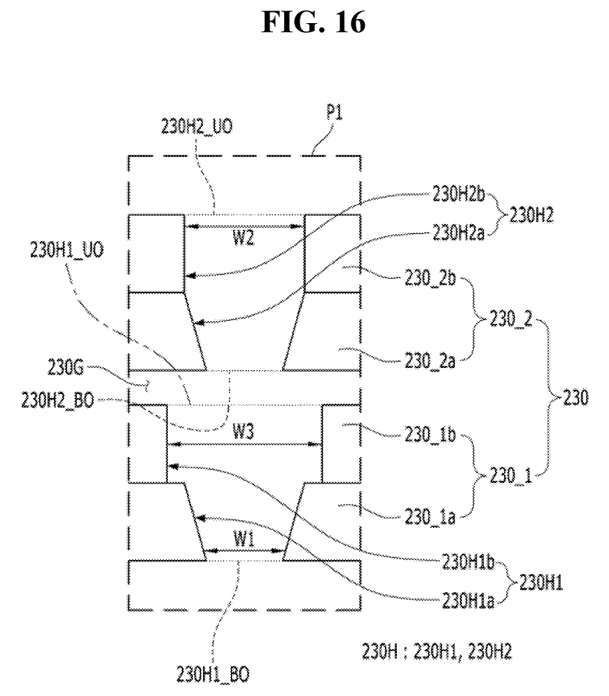

Referring to FIG. 16, the first_1 scrubbing plate 230_1 and the first_2 scrubbing plate 230_2 may be spaced apart from each other in the second direction D2. For convenience of explanation, overlapping descriptions with FIG. 15 are omitted.

A scrubbing gap 230G may be disposed between the first_1 scrubbing plate 230_1 and the first_2 scrubbing plate 230_2. The scrubbing gap 230G may be provided between the upper surface of the first_1 scrubbing plate 230_1 and the lower surface of the first_2 scrubbing plate 230_2. In other words, the upper opening of the first_1 upper scrubbing plate 230_1b may be spaced apart from the lower opening of the first_2 lower scrubbing plate 230_2a in the second direction D2. Stated differently, the upper opening 230H1_UO of the first_1 scrubbing hole 230H1 may be spaced apart from the lower opening 230H2_BO of the first_2 scrubbing hole 230H2 in the second direction D2.

In some embodiments, the scrubbing solution may be supplied to the scrubbing gap 230G. The scrubbing solution may be the above-described second scrubbing solution 227 or may be another scrubbing solution. The scrubbing solution may be water, although the technical scope of the present disclosure is not limited thereto.

When the scrubbing solution is supplied into the scrubbing gap 230G, the scrubbing efficiency of the scrubbing apparatus 20 may be improved.

Referring to FIG. 17, the shape of the first scrubbing hole 230H and the shape of the second scrubbing hole 240H may be different from each other. Although not illustrated, the shape of the third scrubbing hole 250H of FIG. 3 may be different from each of the shape of the first scrubbing hole 230H and the shape of the second scrubbing hole 240H. However, the technical scope of the present disclosure is not limited thereto.

Referring to FIG. 18, in some embodiments, the scrubbing apparatus 20 may include two scrubbing plates 230 and 240. That is, the scrubbing apparatus 20 may include the first scrubbing plate 230 and the second scrubbing plate 240.

The second scrubbing plate 240 may be disposed on the first scrubbing plate 230. The second scrubbing plate 240 may be disposed on the upper surface of the first scrubbing plate 230. The first scrubbing plate 230 may be disposed on the lower surface of the second scrubbing plate 240. Another scrubbing plate may not be disposed on the upper surface of the second scrubbing plate 240.

In some embodiments, the second scrubbing solution 227 may be supplied from the scrubbing solution supply nozzle 223 and discharged onto an upper surface of the second scrubbing plate 240. Specifically, the second scrubbing solution 227 may be discharged onto a region of the upper surface of the second scrubbing plate 240 that is adjacent to the second inner side wall 210SW2 of the scrubbing chamber 210. The second scrubbing solution 227 may be discharged onto a region of the upper surface of the second scrubbing plate 240 that is farthest from the second scrubbing wall 245.

The discharged second scrubbing solution 227 may flow on the upper surface of the second scrubbing plate 240 toward the second scrubbing wall 245 while the second scrubbing process is being performed. The second scrubbing solution 227 may flow downward beyond the second scrubbing wall 245. At this time, the second scrubbing solution 227 may not flow downward through the second scrubbing holes 240H. The second scrubbing solution 227 that flows downward beyond the second scrubbing wall 245 may be discharged onto the upper surface of the first scrubbing plate 230.

Similarly, during the second scrubbing process, the second scrubbing solution 227 may flow on the upper surface of the first scrubbing plate 230 toward the first scrubbing wall 235. At this time, the second scrubbing solution 227 may not flow downward through the first scrubbing holes 230H. The second scrubbing solution 227 may flow downward beyond the first scrubbing wall 235 into the lower part of the scrubbing chamber 210.

The scrubbing apparatus 20 illustrated in FIG. 18 includes only two scrubbing plates 230 and 240. Accordingly, the height of the scrubbing apparatus 20 in the second direction D2 may be reduced. That is, when the scrubbing apparatus 20 according to some embodiments of the present disclosure is used, space efficiency may be improved.

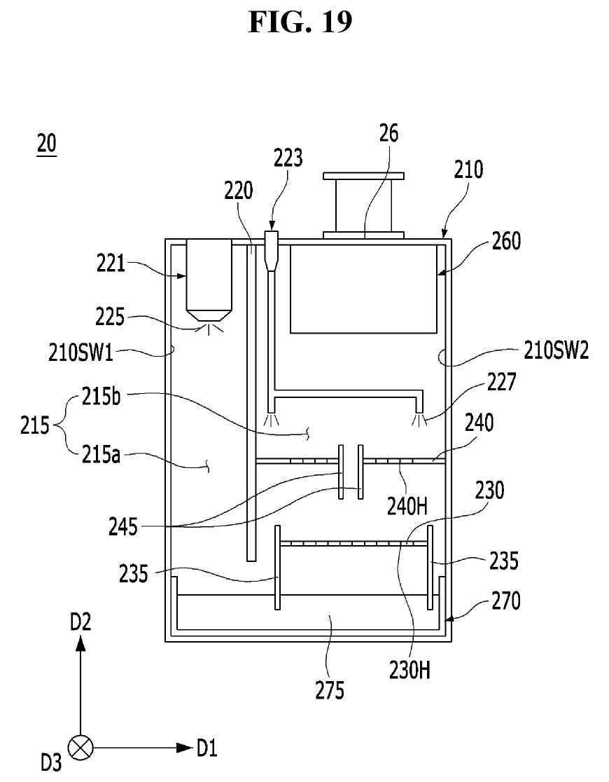

Referring to FIG. 19, in some embodiments of the present disclosure, the shape of the first scrubbing plate 230 and the shape of the second scrubbing plate 240 may be different from each other.

For example, both ends of the first scrubbing plate 230 may be spaced apart from the separating wall 220 and the second inner side wall 210SW2, respectively. Specifically, the first scrubbing plate 230 may not be in contact with or connected to either the separating wall 220 or the second inner side wall 210SW2. Although not illustrated, the first scrubbing plate 230 may be in contact with and connected to the third inner side wall and the fourth inner side wall. The first scrubbing plate 230 may extend in the third direction D3.

A pair of first scrubbing walls 235 may be disposed at one end and the other end of the first scrubbing plate 230. Some of the pair of first scrubbing walls 235 may be interposed between the first scrubbing plate 230 and the separating wall 220. The other portion of the pair of first scrubbing walls 235 may be interposed between the first scrubbing plate 230 and the second inner side wall 210SW2.

The space between the first scrubbing wall 235 and the separating wall 220 and the space between the first scrubbing wall 235 and the second inner side wall 210SW2 may each serve as a space through which the second scrubbing solution 227 flows downward (for example, in the second direction D2).

In contrast, the opposite ends of the second scrubbing plate 240 may be connected in contact with the separating wall 220 and the second inner side wall 210SW2, respectively. The second scrubbing plate 240 may have a structure in which a central portion is open.

That is, the second scrubbing plate 240 may include an opening. The opening may be formed at the central portion of the second scrubbing plate 240 and may extend in the third direction D3. The opening may expose at least a portion of the upper surface of the first scrubbing plate 230. In other words, the opening may overlap, in the second direction D2, with at least a portion of the upper surface of the first scrubbing plate 230.

A pair of second scrubbing walls 245 may be disposed at the central portion of the second scrubbing plate 240. The pair of second scrubbing walls 245 may be disposed at the opening, respectively.

The pair of second scrubbing walls 245 may be spaced apart from each other in the first direction D1. A space between the pair of second scrubbing walls 245 may serve as a space through which the second scrubbing solution 227 flows downward (for example, in the second direction D2). In other words, the second scrubbing solution 227 may flow downward through the opening.

In some embodiments, the second scrubbing solution 227 may be discharged at both ends of the second scrubbing plate 240. For example, the second scrubbing solution 227 may be discharged to a region of the second scrubbing plate 240 adjacent to the separating wall 220 and to a region of the second scrubbing plate 240 adjacent to the second inner side wall 210SW2, respectively.

The second scrubbing solution 227 discharged onto the upper surface of the second scrubbing plate 240 may flow toward the central portion of the second scrubbing plate 240. The second scrubbing solution 227 discharged onto the upper surface of the second scrubbing plate 240 may flow toward the opening. While the second scrubbing solution 227 flows toward the central portion of the second scrubbing plate 240, impurities may be dissolved in the second scrubbing solution 227. The second scrubbing solution 227 may flow over the second scrubbing wall 245 and be discharged onto the upper surface of the first scrubbing plate 230. The second scrubbing solution 227 discharged onto the upper surface of the first scrubbing plate 230 may flow toward both ends of the first scrubbing plate 230.

In FIG. 19, the scrubbing device 20 is illustrated as including two scrubbing plates. However, the technical scope of the present disclosure is not limited thereto. For example, when the scrubbing device 20 includes three scrubbing plates, the shape of the third scrubbing plate may be the same as that of the first scrubbing plate 230. The third scrubbing plate may be disposed on the second scrubbing plate 240.

When the scrubbing device 20 includes four scrubbing plates, the shape of the third scrubbing plate may be the same as that of the first scrubbing plate 230, and the shape of the fourth scrubbing plate may be the same as that of the second scrubbing plate 240. The third scrubbing plate may be disposed on the second scrubbing plate 240, and the fourth scrubbing plate may be disposed on the third scrubbing plate.

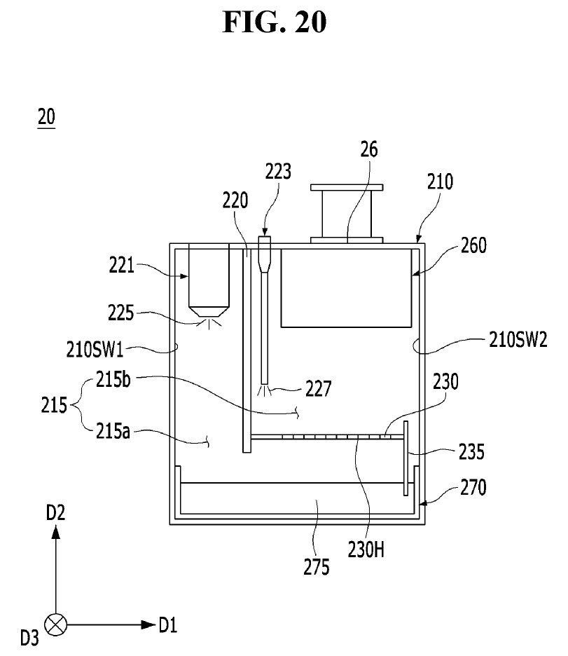

Referring to FIG. 20, in some embodiments, the scrubbing apparatus 20 may include one scrubbing plate 230. That is, the scrubbing apparatus 20 may include the first scrubbing plate 230.

In some embodiments, the second scrubbing solution 227 may be supplied from the scrubbing solution supply nozzle 223 and discharged onto the upper surface of the first scrubbing plate 230. Specifically, the second scrubbing solution 227 may be discharged onto a region of the upper surface of the first scrubbing plate 230 adjacent to the separating wall 220. The second scrubbing solution 227 may be discharged onto a region of the upper surface of the first scrubbing plate 230 farthest from the first scrubbing wall 235.

During the second scrubbing process, the second scrubbing solution 227 may flow on the upper surface of the first scrubbing plate 230 toward the first scrubbing wall 235. In this case, the second scrubbing solution 227 may not flow downward through the first scrubbing hole 230H. Instead, the second scrubbing solution 227 may flow downward beyond the first scrubbing wall 235 to the lower part of the scrubbing chamber 210.

As shown in FIG. 20, since the scrubbing apparatus 20 includes only one scrubbing plate 230, the height of the scrubbing apparatus 20 in the second direction D2 may be reduced. Accordingly, when using the scrubbing apparatus 20 according to some other embodiments of the present disclosure, spatial efficiency may be further improved.

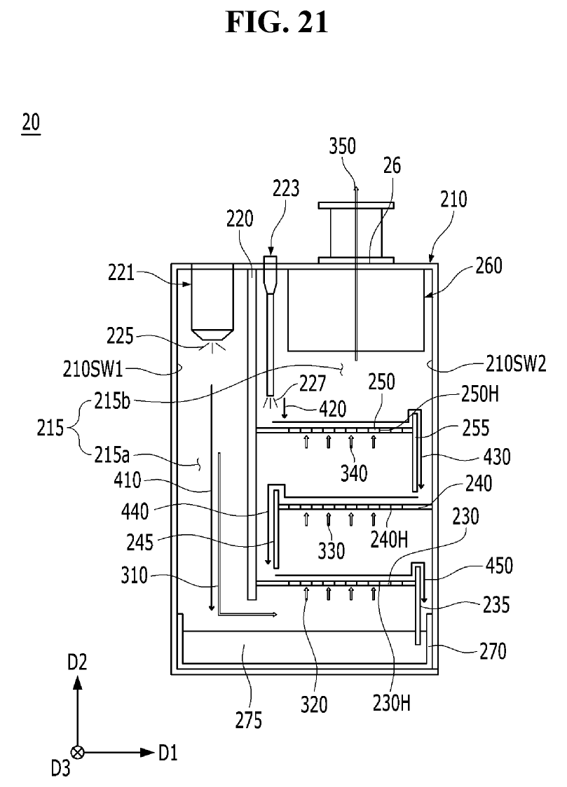

Hereinafter, referring to FIG. 21, an operating method of a scrubbing apparatus according to some embodiments of the present disclosure will be described. FIG. 21 is a drawing for explaining the operating method of the scrubbing apparatus according to some embodiments of the present disclosure.

Referring to FIGS. 1 and 21, gas G including impurities may be provided from the process chamber 10 to the scrubbing apparatus 20. The gas G including impurities may pass through the first pipe 11 and may be introduced into the interior of the scrubbing apparatus 20 through the gas inlet port 25 (see reference numeral 310).

The gas G including impurities may be introduced into the first sub-space 215a. For example, the gas G including impurities may move to the lower part of the first sub-space 215a (see reference numeral 310).

In some embodiments, the first scrubbing process may be performed in the first sub-space 215a.

Specifically, the first scrubbing solution 225 may be supplied into the first sub-space 215a through the spray nozzle 221 (see reference numeral 410). The first scrubbing solution 225 may be water, although the technical scope of the present disclosure is not limited thereto.

In FIG. 21, the first scrubbing solution 225 is illustrated as being sprayed vertically in the second direction D2, although the technical scope of the present disclosure is not limited thereto.

The spray nozzle 221 may supply the first scrubbing solution 225 in fine particle form. As the gas G including impurities moves toward the lower part of the first sub-space 215a, the impurities contained in the gas G may be dissolved in the first scrubbing solution 225. The first scrubbing process may be a process in which the impurities contained in the gas G are dissolved in the first scrubbing solution 225.

The gas G with a portion of impurities removed may be supplied to the second sub-space 215b (see reference numeral 310). The second scrubbing process may be performed in the second sub-space 215b. The second scrubbing process may be a process in which impurities contained in the gas G are dissolved in the second scrubbing solution 227.

In some embodiments, the impurities scrubbed in the first scrubbing process and the impurities scrubbed in the second scrubbing process may be the same, or may be different from each other.

During the second scrubbing process, the scrubbing solution supply nozzle 223 may supply the second scrubbing solution 227 onto the upper surface of the third scrubbing plate 250 (see reference numeral 420). The initially supplied second scrubbing solution 227 may flow downward through the third scrubbing holes 250H, the second scrubbing holes 240H, and the first scrubbing holes 230H. In other words, in the initial state, the second scrubbing solution 227 may flow downward through the scrubbing holes 250H, 240H, and 230H.

During the second scrubbing process, the gas G may ascend in the second direction D2. The gas G may ascend in the second direction D2 while passing through the first scrubbing holes 230H.

Specifically, referring to FIG. 4, the gas G may ascend through the first scrubbing holes 230H. As the gas G ascends in the second direction D2, bubbles BBL may be formed within the second scrubbing solution 227. At the contact area where the bubbles BBL come into contact with the second scrubbing solution 227, impurities contained in the gas G may be dissolved into the second scrubbing solution 227.

During the second scrubbing process, the second scrubbing solution 227 does not flow downward through the scrubbing holes 250H, 240H, and 230H. This may be due to the pressure of the gas G ascending through the scrubbing holes 250H, 240H, and 230H.

During the second scrubbing process, the second scrubbing solution 227 may flow on the upper surface of the third scrubbing plate 250 toward the third scrubbing wall 255 and may then flow over the third scrubbing wall 255 onto the upper surface of the second scrubbing plate 240 (see reference numeral 430). In addition, the second scrubbing solution 227 may flow on the upper surface of the second scrubbing plate 240 toward the second scrubbing wall 245 and may then flow over the second scrubbing wall 245 onto the upper surface of the first scrubbing plate 230 (see reference numeral 440). Furthermore, the second scrubbing solution 227 may flow on the upper surface of the first scrubbing plate 230 toward the first scrubbing wall 235 and may then flow over the first scrubbing wall 235 to the lower part of the scrubbing chamber 210 (see reference numeral 450).

The first scrubbing solution 225 provided in the first sub-space 215a may be stored in the scrubbing solution storage tank 270 after the first scrubbing process is performed. The second scrubbing solution 227 that has flowed over the first scrubbing wall 235 may be stored in the scrubbing solution storage tank 270 after the second scrubbing process is performed. The scrubbing solution storage tank 270 may store a scrubbing solution 275 in which impurities are dissolved. The scrubbing solution 275 in which impurities are dissolved may include the first scrubbing solution in which impurities are dissolved and the second scrubbing solution in which impurities are dissolved.

While the second scrubbing solution 227 flows in the above-described direction, the gas G may ascend in the second direction D2 through the scrubbing holes 250H, 240H, and 230H. As the gas G passes through the scrubbing holes 250H, 240H, and 230H, bubbles may be formed in the second scrubbing solution 227.

Specifically, the gas G may ascend through the first scrubbing holes 230H (see reference numeral 320). Subsequently, the gas G may ascend through the second scrubbing holes 240H (see reference numeral 330). Subsequently, the gas G may ascend through the third scrubbing holes 250H (see reference numeral 340).

As the gas G ascends through the scrubbing holes 250H, 240H, and 230H, impurities included in the gas G may be dissolved into the second scrubbing solution 227.

Subsequently, the gas G from which impurities have been removed may pass through the demister 260 and may be discharged to the outside of the scrubbing chamber 210 (see reference numeral 350). The gas G discharged through the gas outlet port 26 may contain substantially no remaining impurities.

Although the embodiments of the present disclosure have been described with reference to the attached drawings, the present disclosure is not limited to the embodiments described above, but can be manufactured in various different forms, and a person having ordinary skill in the art to which the present disclosure pertains will understand that the present disclosure can be implemented in other specific forms without changing the technical scope or essential features of the present disclosure. Therefore, it should be understood that the embodiments described above are exemplary in all respects and not restrictive.

1. A scrubbing apparatus comprising:
a scrubbing chamber defining a scrubbing space in which impurities contained in a gas are scrubbed;
a first scrubbing plate disposed in the scrubbing chamber;
a plurality of first scrubbing holes penetrating the first scrubbing plate in a second direction; and
a scrubbing solution supplying nozzle configured to supply a scrubbing solution to an upper surface of the first scrubbing plate,
wherein each of the plurality of first scrubbing holes includes an upper opening and a lower opening opposing each other in the second direction,
wherein a width of the upper opening of each of the plurality of first scrubbing holes in a first direction intersecting the second direction is greater than a width of the lower opening of each of the plurality of first scrubbing holes in the first direction, and
wherein some of the impurities contained in the gas ascend through the plurality of first scrubbing holes and are dissolved in the scrubbing solution.

2. The scrubbing apparatus of claim 1, wherein a width of each of the plurality of first scrubbing holes in the first direction gradually decreases from the upper opening toward the lower opening.

3. The scrubbing apparatus of claim 1, wherein the first scrubbing plate comprises a first_1 scrubbing plate and a first_2 scrubbing plate on the first_1 scrubbing plate,
wherein the plurality of first scrubbing holes comprises a plurality of first_1 scrubbing holes penetrating the first_1 scrubbing plate in the second direction and a plurality of first_2 scrubbing holes penetrating the first_2 scrubbing plate in the second direction,
wherein each of the plurality of first_1 scrubbing holes comprises an upper opening and a lower opening opposing each other in the second direction,
wherein each of the plurality of first_2 scrubbing holes comprises an upper opening and a lower opening opposing each other in the second direction, and
wherein the upper opening of each of the plurality of first_1 scrubbing holes lies in the same plane as the lower opening of each of the plurality of first_2 scrubbing holes.

4. The scrubbing apparatus of claim 3, wherein a width of each of the plurality of first_1 scrubbing holes in the first direction is constant, and
wherein a width of each of the plurality of first_2 scrubbing holes in the first direction gradually increases as moving away from the first_1 scrubbing plate in the second direction.

5. The scrubbing apparatus of claim 4, wherein a width of the upper opening of each of the plurality of first_1 scrubbing holes in the first direction is the same as a width of the lower opening of each of the plurality of first_2 scrubbing holes in the first direction.

6. The scrubbing apparatus of claim 3, wherein a width of each of the plurality of first_1 scrubbing holes in the first direction is constant, and
wherein a width of each of the plurality of first_2 scrubbing holes in the first direction is constant.

7. The scrubbing apparatus of claim 3, wherein a center of the upper opening of each of the plurality of first_1 scrubbing holes and a center of the lower opening of each of the plurality of first_2 scrubbing holes are offset from each other in the second direction.

8. The scrubbing apparatus of claim 1, wherein the plurality of first scrubbing holes comprises a plurality of first_1 scrubbing holes and a plurality of first_2 scrubbing holes on the plurality of first_1 scrubbing holes.

9. The scrubbing apparatus of claim 8, wherein, at a boundary between each of the plurality of first_1 scrubbing holes and each of the plurality of first_2 scrubbing holes, a width of each of the plurality of first_1 scrubbing holes in the first direction is smaller than a width of each of the plurality of first_2 scrubbing holes in the first direction.

10. The scrubbing apparatus of claim 8, wherein a width of each of the plurality of first_2 scrubbing holes in the first direction is constant, and
wherein a width of each of the plurality of first_1 scrubbing holes in the first direction gradually decreases as moving away from the plurality of first_2 scrubbing holes in the second direction.

11. The scrubbing apparatus of claim 10, wherein, at a boundary between each of the plurality of first_1 scrubbing holes and each of the plurality of first_2 scrubbing holes, a width of each of the plurality of first_1 scrubbing holes in the first direction is equal to a width of each of the plurality of first_2 scrubbing holes in the first direction.

12. The scrubbing apparatus of claim 8, wherein a height of each of the plurality of first_1 scrubbing holes in the second direction is different from a height of each of the plurality of first_2 scrubbing holes in the second direction.

13. The scrubbing apparatus of claim 8, wherein each of the plurality of first_1 scrubbing holes comprises a plurality of first_1 lower scrubbing holes and a plurality of first_1 upper scrubbing holes on the plurality of first_1 lower scrubbing holes,
wherein each of the plurality of first_2 scrubbing holes comprises a plurality of first_2 lower scrubbing holes and a plurality of first_2 upper scrubbing holes on the plurality of first_2 lower scrubbing holes, and
wherein a volume of each of the plurality of first_1 upper scrubbing holes is greater than a volume of each of the plurality of first_2 upper scrubbing holes.

14. The scrubbing apparatus of claim 13, wherein each of the plurality of first_1 upper scrubbing holes comprises an upper opening,
wherein each of the plurality of first_2 lower scrubbing holes comprises a lower opening, and
wherein the upper opening of each of the first_1 upper scrubbing holes is spaced apart from the lower opening of each of the first_2 lower scrubbing holes in the second direction.

15. The scrubbing apparatus of claim 1, further comprising:
a second scrubbing plate disposed in the scrubbing chamber and on the first scrubbing plate; and
a plurality of second scrubbing holes penetrating the second scrubbing plate in the second direction,
wherein each of the plurality of second scrubbing holes comprises an upper opening and a lower opening opposing each other in the second direction, and
wherein a width of the upper opening of each of the plurality of second scrubbing holes in the first direction is greater than a width of the lower opening of each of the plurality of second scrubbing holes in the first direction.

16. The scrubbing apparatus of claim 15, wherein a shape of each of the plurality of first scrubbing holes is different from a shape of each of the plurality of second scrubbing holes.
